(19) United States
(12) Patent Application Publication
(10) Pub. No.: US 2021/0392598 A1
(43) Pub. Date: Dec. 16, 2021

(54) SUPPORT BEACON(S) FOR SYNCHRONIZATION TO A MULTICAST MESSAGE IN NON-COORDINATED NETWORKS

(71) Applicant: Fraunhofer-Gesellschaft zur Förderung angewandten Forschung e.V., Munich (DE)

(72) Inventors: Gerd KILIAN, Erlangen (DE); Josef BERNHARD, Erlangen (DE); Johannes WECHSLER, Erlangen (DE); Jakob KNEISSL, Erlangen (DE); Dominik SOLLER, Erlangen (DE); Michael SCHLICHT, Erlangen (DE); Thomas KAUPPERT, Nuernberg (DE); Hristo PETKOV, Nuernberg (DE); Raphael MZYK, Kammerstein (DE); Klaus GOTTSCHALK, Winkelhaid (DE)

(21) Appl. No.: 17/458,828

(22) Filed: Aug. 27, 2021

Related U.S. Application Data
(63) Continuation of application No. PCT/EP2020/055164, filed on Feb. 27, 2020.

(30) Foreign Application Priority Data
Feb. 28, 2019 (DE) 102019202742.3

(51) Int. Cl. H04W 56/00; H04L 12/18

(52) U.S. Cl. CPC H04W 56/0005; H04L 12/189

(57) ABSTRACT

Embodiments of the present invention provide a participant of a communication system, wherein the communication system communicates wirelessly in a frequency band used by a plurality of communication systems, wherein the participant is configured to transmit data uncoordinatedly with respect to other participants and/or a base station of the communication system, wherein the participant is configured to receive one or several support beacons from the base station of the communication system, wherein the one or several support beacons include synchronization information, wherein the participant is configured to receive a point-to-multipoint data transfer of the base station on the basis of the synchronization information.

### CROSS-REFERENCES TO RELATED APPLICATIONS

This application is a continuation of copending International Application No. PCT/EP2020/055164, filed Feb. 27, 2020, which is incorporated herein by reference in its entirety, and additionally claims priority from German Applications No. DE 10 2019 202 742.3, filed Feb. 28, 2019, which is incorporated herein by reference in its entirety.

Embodiments of the present invention relate to a wireless communication system with a multitude of uncoordinatedly transmitting participants, and in particular to the transfer of a multicast message (point-to-multipoint message) in such a communication system. Some embodiments relate to the transfer of one or several support beacons prior to the multicast message (point-to-multipoint message).

### BACKGROUND OF THE INVENTION

In typical radio networks (or wireless communication systems), such as GSM (Global System for Mobile Communications), there is a coordinating instance that provides radio resources to participants of the radio network, as needed, which are exclusively available to the respective participant.

This can ensure that each participant may transfer its data in a radio resource that is reserved exclusively for it. This avoids interferences between the participants of a radio network and therefore maximizes the throughput.

In such radio networks, the coordination of the participants with respect to radio resources is performed usually by means of so-called beacons which the participants of the network listen to. With the signalization of the radio resources in these beacons, it is a requirement for all participants to receive and evaluate them so as to be able to subsequently receive or transmit data. Thus, a participant that rarely accesses the channel has a very high current consumption.

In contrast, another approach is a non-coordinated radio network in which the participants transfer their data to the receiver in a contention-based manner. Thus, a beacon that signals when and which participant is allowed to transmit on which frequency does not have to be received continuously. This reduces the current consumption of the participants since they only have to be activated as needed.

However, this method has the disadvantage that there may be interferences between the participants of the radio network. However, this disadvantage may be reduced by the use of “Telegram Splitting Multiple Access” (TSMA) [4], which allows obtaining throughputs similar to coordinated systems.

In “Telegram Splitting Multiple Access” (TSMA), the transfer of a message (data packet) is divided into a plurality of short sub-data packets (bursts) between each of which there are transfer-free time intervals of different lengths. In this case, the sub-data packets are distributed pseudo-randomly across time and available frequency channels, as is exemplarily shown in FIG. 1.

In detail, FIG. 1 shows, in a diagram, an occupancy of a frequency band of a TSMA-based communication system in the transfer of a data packet divided onto a plurality of sub-data packets 10, wherein the plurality of sub-data packets are distributed in time and frequency. In FIG. 1, the ordinate describes the frequency (frequency channels), and the abscissa describes the time. In other words, FIG. 1 shows the principle of the data transfer according to the TSMA method.

[1] showed that the TSMA method may achieve a larger capacity in the data transfer in contrast to the transfer of a data packet in a continuous block, i.e. without subdivision into sub-data packets 10. In order to achieve as large a system capacity as possible, as many different time and/or frequency hopping patterns as possible should be used [3]. The total number of the time and/or frequency hopping patterns should be finite, and should originate from an inventory of time and/or frequency hopping patterns known in advance.

The contention-based access to the channel at random points in time results in an asynchronous transfer, as is exemplarily shown in FIG. 2 for a communication system without TSMA.

In detail, FIG. 2 shows, in a diagram, an occupancy of a frequency band of a contention-based communication system in the transfer of several uplink messages 12 and several downlink messages 14. In FIG. 2, the abscissa describes the frequency, and the ordinate describes the time. In other words, FIG. 2 shows a schema of a transfer channel in a non-coordinated communication system.

In a non-coordinated communication system, there are usually several participants (e.g. terminal points) that communicate with a base station. In this case, the transfer of a message from a participant to the base station is the uplink, and the downlink takes place in the opposite direction.

For reasons of energy efficiency, the participants usually only turn on their transmission/reception module when they want to transmit a message. Thus, the reception of one of the downlink messages 14, as shown in FIG. 2, is not possible.

To solve this problem, [4] has defined that the participant waits for a specifically defined time after the emission of an uplink message to then open a reception window for a downlink message. Thus, the base station can transmit a downlink message to this participant at a certain point in time only.

Typically, the downlink to the participants employing the uncoordinated transfer is used for messages that are to be transferred to several participants, e.g. software updates or time-sync commands.

Due to the asynchronous network approach from [4] (contention-based access), the downlink message has to be separately shared with each participant. Particularly in large radio networks with many participants, this is a problem since, with a large number of participants, it would take a very long time until all participants have obtained the data.

In coordinated communication systems it is possible to signal in a beacon a point-to-multipoint message (multicast message) from the base station to the participants. All participants having received the beacon may subsequently also receive the corresponding resources of the multicast message.

### SUMMARY

An embodiment may have a participant of a communication system, wherein the participant is configured to transmit data uncoordinatedly with respect to other participants and/or a base station of the communication system, wherein the participant is configured to receive one or several support beacons from the base station of the communication system, wherein the one or several support beacons comprise synchronization information, wherein the participant is configured to receive a point-to-multipoint data transfer of the base station on the basis of the synchronization information, wherein the participant is configured to receive, temporally synchronized to an uplink data transfer transmitted to the base station, a downlink data transfer from the base station, wherein the downlink data transfer comprises signaling information, wherein the signaling information signals the transfer of the support beacon or of at least one of the several support beacons, wherein the participant is configured to receive the one or at least one of the several support beacons on the basis of the signaling information.

Another embodiment may have a base station of a communication system, wherein the base station is configured to transmit one or a plurality of support beacons, wherein the one or the plurality of support beacons comprise synchronization information for synchronizing uncoordinatedly-transmitting participants of the communication system, wherein the base station is configured to transmit the point-to-multipoint data transfer, wherein the base station is configured to receive an uplink data transfer from one of the participants of the communication system, wherein the uplink data transfer is uncoordinated, wherein the base station is configured to transmit, temporally synchronized to the received uplink data transfer of the participant, a downlink data transfer to the participant, wherein the downlink data transfer comprises signaling information, wherein the signaling information signals the transfer of the support beacon or of at least one of the plurality of support beacons.

Another embodiment may have a participant of a communication system, wherein the participant is configured to transmit data uncoordinatedly with respect to other participants and/or a base station of the communication system, wherein the participant is configured to receive one or several support beacons from the base station of the communication system, wherein the one or several support beacons comprise synchronization information, wherein the participant is configured to receive a point-to-multipoint data transfer of the base station on the basis of the synchronization information, wherein at least one of the support beacons comprises information about a transfer of a subsequent support beacon, wherein the participant is configured to receive at least one of the subsequent support beacons on the basis of the information about the transfer of a subsequent support beacon.

Another embodiment may have a base station of a communication system, wherein the base station is configured to transmit one or a plurality of support beacons, wherein the one or the plurality of support beacons comprise synchronization information for synchronizing uncoordinatedly-transmitting participants of the communication system, wherein the base station is configured to transmit the point-to-multipoint data transfer, wherein the base station is configured to provide at least one of the support beacons with information about a transfer of a subsequent support beacon.

Embodiments provide a participant of a communication system, [wherein the communication system communicates wirelessly in a frequency band [e.g. the ISM band] used by a plurality of [e.g. mutually uncoordinated] communication systems], wherein the participant is configured to transmit data uncoordinatedly with respect to other participants and/or a base station of the communication system, wherein the participant is configured to receive one or several [e.g. at least two] support beacons from the base station of the communication system [e.g. preceding a point-to-multipoint data transfer], wherein the one or several support beacons [e.g. each] comprise synchronization information [e.g. for synchronizing the participant [e.g. to the respective support beacon, to a point-to-multipoint data transfer of the base station and/or to at least one further support beacon [e.g. preceding the point-to-multipoint data transfer]]], wherein the participant is configured to receive a point-to-multipoint data transfer of the base station on the basis of the synchronization information.

In embodiments, the participant may be configured to receive, temporally synchronized to an uplink data transfer transmitted to the base station, a downlink data transfer from the base station, wherein the downlink data transfer comprises signaling information, wherein the signaling information signals the transfer of the support beacon or of at least one of the several support beacons, wherein the participant is configured to receive the one or at least one of the several support beacons [e.g. at least the [temporally] first support beacon] on the basis of the signaling information.

In embodiments, the signaling information may comprise information about at least one of:
a point in time or time interval of the transfer of the one support beacon or of at least one of the several support beacons,
a frequency channel or frequency interval of the transfer of the one support beacon or of at least one of the several support beacons, and
a time and/or frequency hopping pattern on the basis of which the support beacons are transferred.

For example, the information about the point in time may be an absolute point in time, a relative point in time [e.g. a defined time span between the downlink data transfer and the support beacon], or information from which the absolute or relative point in time may be derived, such as a number of clock cycles of an oscillator of the terminal point.

For example, the information about the frequency channel may be an absolute frequency channel or a relative frequency channel [e.g. an interval between a frequency channel of the downlink data transfer and a frequency channel of the support beacon].

For example, the support beacon may be transferred on the basis of the telegram splitting transfer method. In the transfer of the support beacon on the basis of the telegram splitting transfer method, data [e.g. a [encoded] support beacon data packet of the physical layer] to be transferred with the support beacon may be divided onto a plurality of sub-data packets so that the plurality of sub-data packets each comprise only a part of the data to be transferred, wherein the plurality of sub-data packets are not transferred continuously, but distributed in time and/or frequency according to a time and/or frequency hopping pattern.

In embodiments, the synchronization information may comprise information about at least one of:
a point in time or time interval of the transfer of a further support beacon and/or of the point-to-multipoint data transfer,
a frequency channel or frequency interval of the transfer of a further support beacon and/or of the point-to-multipoint data transfer, and
a time and/or frequency hopping pattern on the basis of which the further support beacon and/or the point-to-multipoint data transfer is transferred.

In embodiments, the synchronization information may comprise a synchronization sequence for synchronizing the participant to the respective support beacon, wherein the participant is configured to synchronize itself to the respective support beacon on the basis of the synchronization sequence [e.g. on the basis of a correlation of a reception data stream with a reference sequence corresponding to the synchronization sequence so as to detect the synchronization sequence [e.g. and therefore the respective support beacon] in the reception data stream].

In embodiments, the participant may be configured to receive the several support beacons so as to synchronize itself and/or maintain itself synchronized to the point-to-multipoint data transfer of the base station on the basis of the synchronization information contained in the support beacons.

In embodiments, the several support beacons may be transferred in regular intervals or in intervals that are regular on average, wherein the participant knows the intervals between the transfers of the support beacons [e.g. from a preceding downlink transfer or a support beacon already received].

In embodiments, the several support beacons may be transferred at specified [e.g. across the system or for the point-to-multipoint data transfer] points in time and/or with specified time intervals and/or in specified frequency channels and/or in specified frequency channel intervals and/or according to a specified time hopping pattern and/or according to a specified frequency hopping pattern.

In embodiments, at least one of [e.g. all of [e.g. with the exception of the last]] the support beacons [e.g. or the synchronization information of at least one of the support beacons] may comprise information about a transfer of a subsequent [e.g. the respectively subsequent] support beacon, [e.g. wherein the information about the transfer is a point in time and/or a time interval and/or a frequency channel and/or a frequency channel interval and/or a time hopping pattern and/or a frequency hopping pattern], wherein the participant is configured to receive the [respectively] subsequent support beacon on the basis of the information about the transfer of the [e.g. respectively] subsequent support beacon.

In embodiments, a point in time and/or a frequency channel of the transfer of at least one of [e.g. all of [e.g. with the exception of the first]] the support beacons may be derived from information [e.g. CRC or support beacon counter] transferred with a preceding support beacon, wherein the participant is configured to derive the point in time and/or the frequency channel of the transfer of the at least one [e.g. respective] support beacon from the information transferred with the [e.g. respectively] preceding support beacon so as to receive the at least one [e.g. respective] support beacon.

In embodiments, points in time and/or frequency channels, or a time hopping pattern and/or a frequency hopping pattern of the transfer of the several support beacons may be determined on the basis of a calculation rule [e.g. a polynomial of a LFSR or a PRBS generator], wherein the signaling information and/or the synchronization information of at least one of the support beacons comprises information about a current state of the calculation rule, wherein the participant is configured to determine the points in time and/or the frequency channels, and/or the time hopping pattern and/or the frequency hopping pattern of the transfer of the several support beacons on the basis of the calculation rule and the current state of the calculation rule so as to receive the several support beacons.

In embodiments, the several support beacons received by the participant may be a real subset [e.g. only a part] of the support beacons emitted by the base station.

In embodiments, the participant may be configured to transmit, if at least one of the support beacons could not be received successfully [e.g. due to transfer errors], a further uplink data transfer to the base station and to receive, temporally synchronized to the further uplink data transfer, a further downlink data transfer, wherein the further downlink data transfer comprises further signaling information, wherein the further signaling information signals the transfer of at least one further [e.g. subsequent] support beacon, wherein the participant is configured to receive the at least one further [e.g. subsequent] support beacon on the basis of the signaling information.

In embodiments, the participant may be configured to receive, if at least one of the support beacons could not be received successfully [e.g. due transfer errors], a subsequent support beacon with an increased synchronization effort [e.g. on the basis of an extended time and/or frequency search window].

In embodiments, payload data of the point-to-multipoint data transfer [e.g. payload data to be transferred with the point-to-multipoint data transfer] may be divided into a plurality of payload data parts, wherein at least one part of the payload data parts [e.g. of one of the payload data portions each] may be respectively transferred together with a support beacon [e.g. in a transfer frame of a support beacon].

For example, payload data to be transferred with the point-to-multipoint data transfer may be divided into several payload data parts and may be transferred together with the support beacons [e.g. in the transfer frames of the support beacons].

For example, a data packet [e.g. of the physical layer] [e.g. with the payload data] to be transferred with the point-to-multipoint data transfer may be divided into several partial data packets, wherein the partial data packets are each transferred together with one of the support beacons [e.g. in the transfer frames of the respective support beacons].

In embodiments, at least a part of the payload data parts may be transferred several times together with different support beacons.

For example, a support beacon may also comprise a payload data part and duplicated payload data portion, or only a single payload data part or duplicated payload data part. In the latter case, a number of support beacons is at least as large as a sum of a number of payload data parts and a number of duplicated payload data parts.

In embodiments, the payload data or payload data parts may be channel-encoded so that only a part of the payload data parts is required to decode the payload data, wherein only a part of the payload data parts is transferred together with the support beacons, or wherein the participant is configured to stop a reception of the support beacons with the payload data parts if a sufficient number of payload data parts for decoding the payload data was received.

In embodiments, the [e.g. synchronization information of the] support beacon or at least one of several support beacons [e.g. the last support beacon] may comprise information about the point-to-multipoint data transfer, wherein the participant is configured to receive the point-to-multipoint data transfer on the basis of the information about the point-to-multipoint data transfer.

In embodiments, the information about the point-to-multipoint data transfer may be information about at least one of:
a point in time or time interval of the point-to-multipoint data transfer,
a frequency channel or frequency interval of the point-to-multipoint data transfer,
a time and/or frequency hopping pattern of the point-to-multipoint data transfer.

For example, the information about the point in time may be an absolute point in time, a relative point in time [e.g. a defined time span between the support beacon and the point-to-multipoint data transfer], or information from which the absolute or relative point in time may be derived, such as a number of clock cycles of an oscillator of the terminal point.

For example, the information about the frequency channel may be an absolute frequency channel or a relative frequency channel [e.g. a distance between a frequency channel of the support beacon and a frequency channel of the point-to-multipoint data transfer].

For example, the point-to-multipoint data transfer may be a telegram splitting-based data transfer. In a telegram splitting-based data transfer, the data to be transferred [e.g. [encoded] payload data of the physical layer] is divided onto a plurality of sub-data packets so that the plurality of sub-data packets each comprise only a part of the data to be transferred, wherein the plurality of sub-data packets is not transferred continuously, but distributed in time and/or frequency according to a time and/or frequency hopping pattern.

In embodiments, the support beacon or at least one of the several support beacons may comprise point-to-multipoint data transfer allocation information, wherein one of several point-to-multipoint data transfers of the base station is allocated for reception to the participant on the basis of the point-to-multipoint data transfer allocation information.

Further embodiments provide a base station of a communication system, [wherein the communication system communicates wirelessly in a frequency band [e.g. the ISM band] used by a plurality of [e.g. mutually uncoordinated] communication systems], wherein the base station is configured to transmit one or a plurality of [e.g. at least two] support beacons [e.g. preceding a [e.g. upcoming or planned] point-to-multipoint data transfer], wherein the one or the plurality of support beacons [e.g. each] comprise synchronization information for synchronizing uncoordinatedly-transmitting participants of the communication system [e.g. to the respective support beacon, to a point-to-multipoint data transfer of the base station and/or to at least one further support beacon [e.g. preceding the point-to-multipoint data transfer]], wherein the base station is configured to transmit the point-to-multipoint data transfer [e.g. according to the synchronization information].

In embodiments, the base station may be configured to receive an uplink data transfer from one of the participants of the communication system, wherein the uplink data transfer is uncoordinated, wherein the base station is configured to transmit, temporally synchronized to the received uplink data transfer of the participant, a downlink data transfer to the participant, wherein the downlink data transfer comprises signaling information, wherein the signaling information signals the transfer of the support beacon or of at least one of the plurality of support beacons.

In embodiments, the signaling information may comprise information about at least one of:
a point in time or time interval of the transfer of the one support beacon or of at least one of the several support beacons,
a frequency channel or frequency interval of the transfer of the one support beacon or of at least one of the several support beacons, and
a time and/or frequency hopping pattern on the basis of which the support beacons are transferred.

For example, the information about the point in time may be an absolute point in time, a relative point in time [e.g. a defined time span between the downlink data transfer and the support beacon], or information from which the absolute or relative point in time may be derived, such as a number of clock cycles of an oscillator of the terminal point.

For example, the information about the frequency channel may be an absolute frequency channel or a relative frequency channel [e.g. an interval between a frequency channel of the downlink data transfer and a frequency channel of the support beacon].

For example, the support beacon may be transferred on the basis of the telegram splitting transfer method. In the transfer of the support beacon on the basis of the telegram splitting transfer method, data [e.g. a [encoded] support beacon data packet of the physical layer] to be transferred with the support beacon may be divided onto a plurality of sub-data packets so that the plurality of sub-data packets each comprise only a part of the data to be transferred, wherein the plurality of sub-data packets are not transferred continuously, but distributed in time and/or frequency according to a time and/or frequency hopping pattern.

In embodiments, the synchronization information may comprise information about at least one of:
a point in time or time interval of the transfer of a further support beacon or of the point-to-multipoint data transfer,
a frequency channel or frequency interval of the transfer of a further support beacon or of the point-to-multipoint data transfer, and
a time and/or frequency hopping pattern on the basis of which the further support beacon or the point-to-multipoint data transfer is transferred.

In embodiments, the synchronization information may comprise a synchronization sequence for synchronizing the participant to the respective support beacon.

In embodiments, the support beacons may each comprise synchronization information for synchronizing and/or maintaining the synchronization of participants to the point-to-multipoint data transfer.

In embodiments, the base station may be configured to transfer the plurality of support beacons in regular intervals or in intervals that are regular on average.

In embodiments, the base station may be configured to transfer the plurality of support beacons at specified points in time and/or with specified time intervals and/or in specified frequency channels and/or in specified frequency channel intervals and/or according to a specified time hopping pattern and/or according to a specified frequency hopping pattern.

In embodiments, the base station may be configured to provide at least one [e.g. each [e.g. with the exception of the last]] of the support beacons [e.g. or the synchronization information of at least one of the support beacons] with information about a transfer of a subsequent [e.g. the respectively subsequent] support beacon, [e.g. wherein the information about the transfer is a point in time and/or a time interval and/or a frequency channel and/or a frequency channel interval and/or a time hopping pattern and/or a frequency hopping pattern].

In embodiments, the base station may be configured to adapt [e.g. decrease the interval when including participants with a greater time deviation] the transfer intervals of the support beacons to the temporal accuracy [e.g. the Q factor of the clock generator] of the participants determined for the reception of the support beacons.

In embodiments, the base station may be configured to derive a point in time and/or a frequency channel of the transfer of at least one of [e.g. each of [e.g. with the exception of the first]] the support beacons from information [e.g. CRC or support beacon counter] transferred with a preceding support beacon.

In embodiments, the base station may be configured to determine points in time and/or frequency channels and/or a time hopping pattern and/or a frequency hopping pattern of the transfer of the several support beacons on the basis of a calculation rule [e.g. a polynomial of a LFSR or a PRBS generator], wherein the base station is configured to provide the signaling information and/or the synchronization information of at least one of the support beacons with information about a current state of the calculation rule.

In embodiments, the base station may be configured to divide payload data of the point-to-multipoint data transfer [e.g. payload data to be transferred with the point-to-multipoint data transfer] into a plurality of payload data parts, wherein the base station is configured to transfer at least a part of the payload data parts [e.g. of at least one of the payload data portions each] each together with a support beacon [e.g. in a transfer frame of a support beacon].

For example, the base station may be configured to divide payload data to be transferred with the point-to-multipoint data transfer into several payload data parts and to emit them together with the support beacons [e.g. in the transfer frames of the support beacons].

For example, the base station may be configured to divide a data packet [e.g. of the physical layer] [e.g. with the payload data] to be transferred with the point-to-multipoint data transfer into several partial data packets and to emit the partial data packets each together with one of the support beacons [e.g. in the transfer frames of the respective support beacons].

In embodiments, the base station may be configured to transfer at least a part of the payload data parts several times [e.g. cyclically repeated] together with different support beacons.

For example, a support beacon may comprise a payload data part or a duplicated payload data portion, or also a single payload data part or a duplicated payload data part. In the latter case, a number of support beacons is therefore at least as large as a sum of a number of payload data parts and a number of duplicated payload data parts.

In embodiments, the base station may be configured to dynamically adapt the payload data portion, wherein the adaption is based on at least one parameter of:
a utilization of the base station [e.g. allowed or possible transmission time, duty cycle],
a utilization of the radio channel, and
a number of the participants having obtained signaling information for at least one of the support beacons.

In embodiments, the base station may be configured to channel-encode the payload data or payload data parts so that only a part of the payload data parts is required to decode payload data, wherein the base station is configured to transfer only a part [e.g. a real subset] of the payload data parts together with the support beacons, or wherein the base station is configured to stop a transmission of the support beacons with the payload data parts if a sufficient number of payload data parts for decoding the payload data was emitted.

In embodiments, the base station may be configured to provide the [e.g. synchronization information of the] support beacon or at least one of the plurality of support beacons [e.g. the last support beacon] with information about the point-to-multipoint data transfer.

In embodiments, the information about the point-to-multipoint data transfer may be information about at least one of:
a point in time or time interval of the point-to-multipoint data transfer,
a frequency channel or frequency interval of the point-to-multipoint data transfer,
a time and/or frequency hopping pattern of the point-to-multipoint data transfer.

For example, the information about the point in time may be an absolute point in time, a relative point in time [e.g. a defined time span between the support beacon and the point-to-multipoint data transfer], or information from which the absolute or relative point in time may be derived, such as a number of clock cycles of an oscillator of the terminal point.

For example, the information about the frequency channel may be an absolute frequency channel or a relative frequency channel [e.g. a distance between a frequency channel of the support beacon and a frequency channel of the point-to-multipoint data transfer].

For example, the point-to-multipoint data transfer may be a telegram splitting-based data transfer. In a telegram splitting-based data transfer, the data to be transferred [e.g. [encoded] payload data of the physical layer] is divided onto a plurality of sub-data packets so that the plurality of sub-data packets each comprise only a part of the data to be transferred, wherein the plurality of sub-data packets is not transferred continuously, but distributed in time and/or frequency according to a time and/or frequency hopping pattern.

In embodiments, the base station may be configured to provide the support beacon or at least one of the several support beacons with point-to-multipoint data transfer allocation information, wherein one of several point-to-multipoint data transfers of the base station is allocated for reception to groups of participants on the basis of the point-to-multipoint data transfer allocation information.

In embodiments, the base station may be configured to not allocate a point-to-multipoint data transfer to a part of the participants for a time interval in which a point-to-multipoint data transfer is allocated to other participants, wherein the base station is configured to transmit further support beacons for the participants not having allocated a point-to-multipoint data transfer in the time interval.

Further embodiments provide a method for operating an uncoordinatedly-transmitting participant of a communication system. The method includes a step of receiving one or several [e.g. at least two] support beacons from a base station of the communication system [e.g. preceding a point-to-multipoint data transfer], wherein the one or several support beacons comprise synchronization information. Furthermore, the method includes a step of synchronizing the participant to the point-to-multipoint data transfer of the base station on the basis of the synchronization information. In addition, the method includes a step of receiving a point-to-multipoint data transfer of the base station on the basis of the synchronization information.

Further embodiments provide a method for operating a base station of a communication system. The method includes a step of transmitting one or a plurality of [e.g. at least two] support beacons [e.g. preceding a [e.g. upcoming or planned] point-to-multipoint data transfer], wherein the one or the plurality of support beacons comprise synchronization information for synchronizing uncoordinatedly-transmitting participants of the communication system. In addition, the method includes a step of transmitting the point-to-multipoint data transfer [e.g. according to the synchronization information].

### BRIEF DESCRIPTION OF THE DRAWINGS

Embodiments of the present invention will be detailed subsequently referring to the appended drawings, in which:

FIG. 1 shows, in a diagram, an occupancy of a frequency band of a TSMA-based communication system in the transfer of a data packet divided onto a plurality of sub-data packets, wherein the plurality of sub-data packets are distributed in time and frequency,

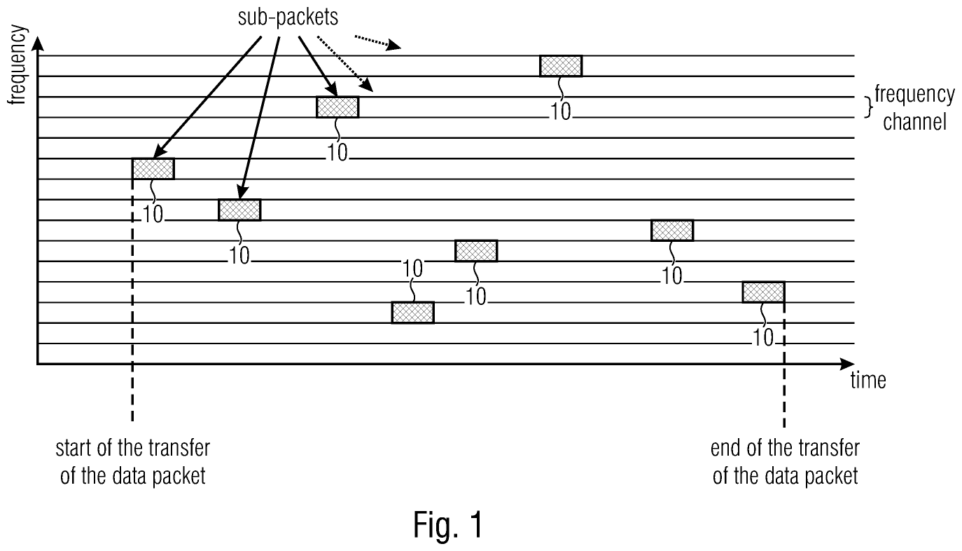

FIG. 2 shows, in a diagram, an occupancy of a frequency band of a contention-based communication system in the transfer of several uplink messages and several downlink messages,

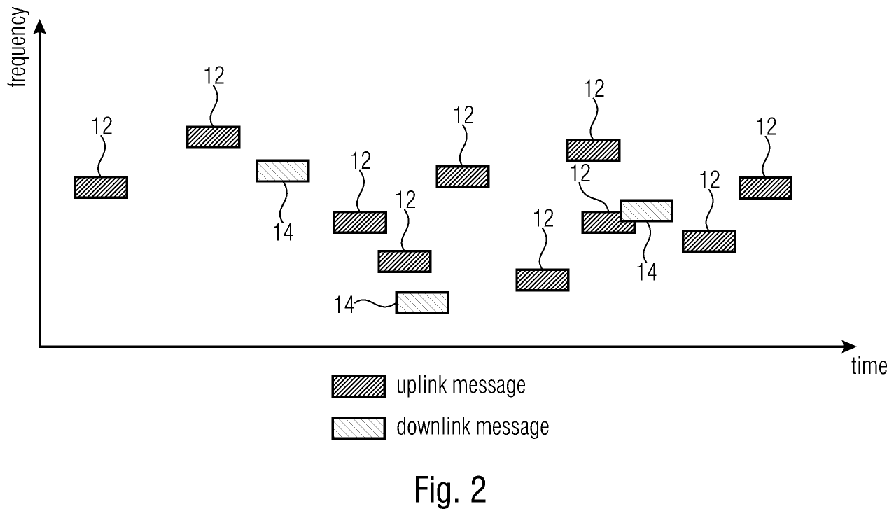

FIG. 3 shows a schematic view of a communication system with one base station and one or several participants as well as two other communication systems, according to an embodiment of the present invention,

FIG. 4 shows a schematic block circuit diagram of the base station and one of the participants of the communication system shown in FIG. 3, according to an embodiment of the present invention,

FIG. 5 shows, in a diagram, an occupancy of a frequency band of the communication system when performing several uplink data transfers and downlink data transfers between the base stations and several of the participants as well as a point-to-multipoint data transfer from the base station to several of the participants, according to an embodiment of the present invention,

FIG. 6 shows a schematic block circuit diagram of a participant and a base station, according to an embodiment of the present invention,

FIG. 7 shows, in a diagram, an occupancy of the frequency band of the communication system when performing an uplink data transfer, a downlink data transfer, and a point-to-multipoint data transfer, according to an embodiment of the present invention,

FIG. 8 shows, in a diagram, an occupancy of the frequency band of the communication system when performing a first uplink data transfer, a first downlink data transfer, a second uplink data transfer, a second downlink data transfer, as well as a point-to-multipoint data transfer, according to an embodiment of the present invention,

FIG. 9 shows, in a diagram, an occupancy of the frequency band of the communication system when performing an uplink data transfer, a downlink data transfer, a transfer of a support beacon as a further data transfer, and a point-to-multipoint data transfer, according to an embodiment of the present invention,

FIG. 10 shows a schematic block circuit diagram of a participant and a base station, according to an embodiment of the present invention,

FIG. 11 shows, in a diagram, an occupancy of the frequency band of the communication system in a point-to-multipoint data transfer and a transfer of several support beacons prior to the point-to-multipoint transfer, according to an embodiment of the present invention,

FIG. 12 shows an occupancy of a frequency band of the communication system in the transfer of a point-to-multipoint data transfer and a transfer of several support beacons, wherein payload data of the point-to-multipoint data transfer is divided onto a plurality of payload data parts and is transferred together with one of the support beacons each, according to an embodiment of the present invention,

FIG. 13 shows, in a diagram, an occupancy of the frequency band of the communication system and the transfer of three point-to-multipoint data transfers for three different groups of participants of the communication system as well as a mutual transfer of support beacons for the three different groups of participants of the communication system, according to an embodiment of the present invention,

FIG. 14 shows a flow diagram of a method for operating an uncoordinatedly-transmitting participant of a communication system, according to an embodiment to the present invention, and

FIG. 15 shows a flow diagram of a method for operating a base station of a communication system, according to an embodiment of the present invention.

### DETAILED DESCRIPTION OF THE INVENTION

In the subsequent description of the embodiments of the present invention, the same elements or elements having the same effect are provided in the drawings with the same reference numerals so that their description is interchangeable.

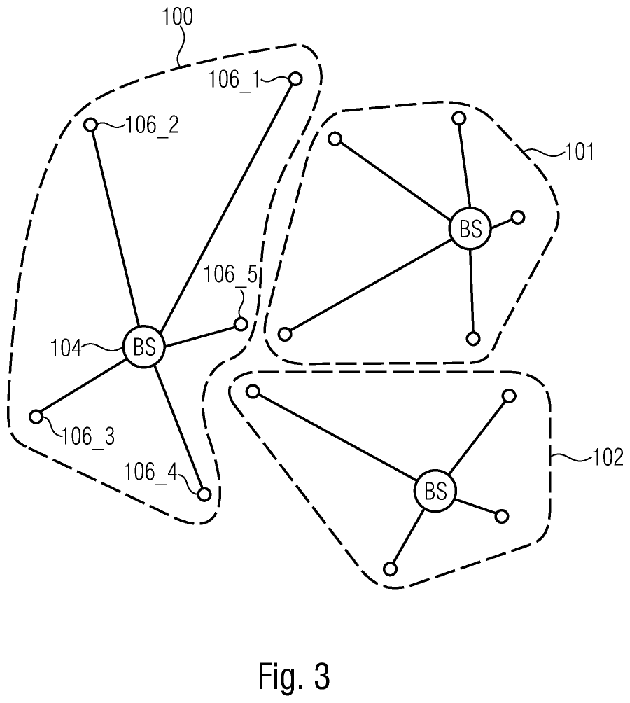

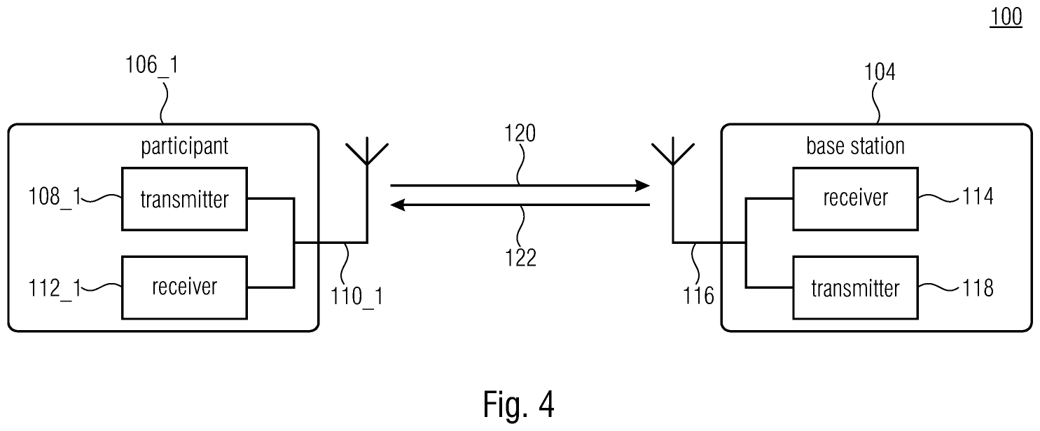

Before describing in detail embodiments of a participant (e.g. a terminal point) and a base station, the underlying communication system in which the participant and/or the base station may be used is described in more detail on the basis of FIGS. 3 and 4.

FIG. 3 shows a schematic view of a communication system 100 and two other communication systems 101 and 102, according to an embodiment of the present invention.

The communication system 100 may comprise a base station 104 (or optionally several base stations) and one or several participants (e.g. terminal points) 106_1-106_n, wherein n is a natural number larger than one. In the embodiment shown in FIG. 3, for illustration purposes, the communication system 100 comprises five participants 106_1-106_5, however, the communication system 104_1 may also comprise 1, 10, 100, 1,000, 10,000 or even 100,000 participants.

The communication system 100 may be configured to communicate wirelessly in a frequency band (e.g. a license-free and/or permission-free frequency band such as the ISM band) used for communication by a plurality of mutually uncoordinated communication systems, as is exemplarily indicated in FIG. 3 by the other communication systems 101 and 102.

The frequency band used by the communication system 100 may have a significantly larger bandwidth (e.g. at least by the factor 5 (or 10)) than reception filters of the receivers (or transceivers) of the participant 106_1-106_n.

The participants 106_1-106_n of the communication system 100 may be configured to transmit data uncoordinatedly (e.g. and asynchronously) with respect to other participants and/or the base station 104 of the communication system 100. For example, the participants 106_1-106_n may be configured to transmit data in specified rough intervals (e.g. hourly, daily, weekly, semi-annually, annually, etc.) or as a reaction to an external event (e.g. a deviation of a sensor value from a target value). In this case, the respective participant may itself determine the exact point in time of the transmission and/or the exact frequency, or the exact frequency channel of the frequency band, for the transfer of the data. In this case, the respective participant transmits the data regardless of whether another participant and/or the base station 104 transfers data at the same point in time or with a temporal overlap and/or on the same frequency, or on the same frequency channel of the frequency band.

In this case, the transfer of data (e.g. a data packet) from one of the participants 106_1-106_n, e.g. from the participant 106_1, to the base station 104 is referred to as the uplink data transfer, whereas the transfer of data from the base station 104 to one of the participants 106_1-106_n, e.g. to the participant 106_1, is referred to as the downlink data transfer. Accordingly, the uplink data transfer refers to (or includes) the transfer of an uplink data packet (or an uplink message) from the respective participant to the base station 104, whereas the downlink data transfer refers to (or includes) the transfer of a downlink data packet (or a downlink message) from the base station 104 to the respective participant.

Since the uplink data transfer of the respective participant 106_1-106_n takes place uncoordinatedly and the transmission/reception unit (transceiver) of the respective participant 106_1-106_n is usually only activated for the data transfer, the downlink data transfer to the respective participant takes place temporally synchronized to the uplink data transfer, i.e. after a specified time and/or frequency after the uplink data transfer, the respective participant activates its transmission/reception unit (transceiver) for a specified time interval (reception window) so as to receive the downlink data transfer that is transmitted exactly within this time interval by the base station 104 as a response to (e.g. as a reaction to) the uplink data transfer. Optionally, the downlink data transfer to the respective participant may also be synchronized in frequency to the respective uplink data transfer, e.g. it may be on the same frequency (in the same frequency channel) or with a specified frequency interval.

This has the advantage that the participants 106_1-106_n have to activate their transmission/reception units (transceivers) only for the respective data transfer (uplink data transfer and/or downlink data transfer) (e.g. in a normal operation mode), while their transmission/reception units may be deactivated for the remaining time (e.g. placed into an energy-saving mode) so as to save energy. In particular, this is of advantage if the respective participant has only limited energy resources, e.g. because it is battery-operated or gathers its energy from the surrounding area by means of an energy-harvesting element. For example, the participants 106_1-106_n of the communication system 100 may be actuator nodes and/or sensor nodes, such as heating meters, motion detectors, smoke detectors, etc.

Optionally, the base station 104 and the participants 106_1-106_n of the communication system 100 may be configured to transfer data on the basis of the telegram splitting method. In this case, on the data transmitter side, the data to be transferred, e.g. a telegram or data packet (e.g. of the physical layer in the OSI model) such as an uplink data packet or a downlink data packet, is divided onto a plurality of sub-data packets (or partial data packets), and the sub-data packets are not transferred continuously, but distributed in time and/or in frequency according to a time and/or frequency hopping pattern, wherein the sub-data packets are merged (or combined) on the data receiver side so as to obtain the data packet. In this case, each of the sub-data packets only contains a part of the data packet. Furthermore, the data packet may be encoded (channel-encoded or error protection-encoded) so that not all of the sub-data packets are required to faultlessly decode the data packet, but only a part of the sub-data packets is required.

As previously mentioned, the distribution of the plurality of sub-data packets in time and/or frequency may be carried out according to a time and/or frequency hopping pattern.

A time hopping pattern may indicate a sequence of points in time of transmission or transmission time intervals with which the sub-data packets are transmitted. For example, a first sub-data packet may be transmitted at a first point in time of transmission (or in a first transmission time slot), and a second sub-data packet may be transmitted at a second point in time of transmission (or in a second transmission time slot), wherein the first point in time of transmission and second point in time of transmission are different. In this case, the time hopping pattern may define (or specify, or indicate) the first point in time of transmission and the second point in time of transmission. Alternatively, the time hopping pattern may indicate the first point in time of transmission and a temporal interval between the first point in time of transmission and the second point in time of transmission. Obviously, the time hopping pattern may also only indicate the temporal interval between the first point in time of transmission and the second point in time of transmission. Between the sub-data packets, there may be transmission pauses in which no transmission takes place. The sub-data packets may also temporally overlap (coincide).

A frequency hopping pattern may indicate a sequence of transmission frequencies or transmission frequency hops with which the sub-data packets are transmitted. For example, a first sub-data packet may be transmitted with a first transmission frequency (or in a first frequency channel) and a second sub-data packet may be transmitted with a second transmission frequency (or in a second frequency channel), wherein the first transmission frequency and the second transmission frequency are different. In this case, the frequency hopping pattern may define (or specify, or indicate) the first transmission frequency and the second transmission frequency. Alternatively, the frequency hopping pattern may indicate the first transmission frequency and a frequency interval (transmission frequency hop) between the first transmission frequency and the second transmission frequency. Obviously, the frequency hopping pattern may also only indicate the frequency interval (transmission frequency hop) between the first transmission frequency and the second transmission frequency.

Obviously, the plurality of sub-data packets may also be transferred distributed in time and frequency. The distribution of the plurality of sub-data packets in time and frequency may be carried out according to a time and frequency hopping pattern. A time and frequency hopping pattern may be the combination of a time hopping pattern and a frequency hopping pattern, i.e. a sequence of points in time of transmission or transmission time intervals with which the sub-data packets are transferred, wherein transmission frequencies (or transmission frequency hops) are assigned to the points in time of transmission (or transmission time intervals).

In this case, a bandwidth of the occupancy of the frequency band indicated by the frequency hopping pattern may be significantly larger (e.g. at least by the factor 5 (or 10)) than a bandwidth of the reception filters of the receivers (receivers or transceivers) of the participants 106_1-106_n. To receive a telegram splitting-based data transfer, the respective participant may therefore be configured to switch, on the basis of the frequency hopping pattern (e.g. at the respective times or time slots indicated by the time hopping pattern), the reception frequency of its receiver to the respective frequencies or frequency channels of the frequency band indicated by the frequency hopping pattern so as to receive the plurality of sub-data packets.

FIG. 4 shows a schematic block circuit diagram of the base station 104 and one of the participants 106_1-106_n of the communication system 100 shown in FIG. 3, according to an embodiment of the present invention.

The participant 106_1 may comprise a transmitter (or a transmission module) 108_1, configured to transmit the uplink data transfer 120 to the base station 104. The transmitter 108_1 may be connected to an antenna 110_1 of the participant 106_1. Furthermore, the participant 106_1 may comprise a receiver (or a reception module) 112_1 configured to receive the downlink data transfer 122 from the base station 104. The receiver 112_1 may be connected to the antenna 110_1 or a further antenna of the participant 106_1. The participant 106_1 may also comprise a combined transmitter/receiver (e.g. transmission/reception module; transceiver).

The base station 104 may comprise a receiver (or reception module) 114 configured to receiver the uplink data transfer 120 from the participant 106_1. The receiver 114 may be connected to an antenna 116 of the base station 104. Furthermore, the base station 104 may comprise a transmitter (or transmission module) 118 configured to transmit the downlink data transfer 122 to the participant 106_1. The transmitter 118 may be connected to the antenna 116 or a further antenna of the base station 104. The base station 104 may also comprise a combined transmitter/receiver (or transmission/reception module; transceiver).

For example, the communication system 100 described with respect to FIGS. 3 and 4 may be a LPWAN (low power wide area network), as is defined in the standard ETSI TSO 103 357 [4], for example.

Embodiments of a participant 106_1 and a base station 104 that may be exemplarily used in the communication system 100 described above with respect to FIGS. 3 and 4 are described in the following. Obviously, the subsequently described embodiments of the participant 106_1 and/or the base station 104 may also implemented in other communication systems with uncoordinatedly transmitting participants.

### 1. Signaling a Multicast Message in Non-Coordinated Networks

The embodiments described in the following enable implementing a multicast message point-to-multipoint data transfer) from the base station 104 to the participants 106_1-106_n or part (real subset) of the participants 106_1-106_n in uncoordinated communication systems 100 in which the participants 106_1-106_n transfer data asynchronously to the base station 104.

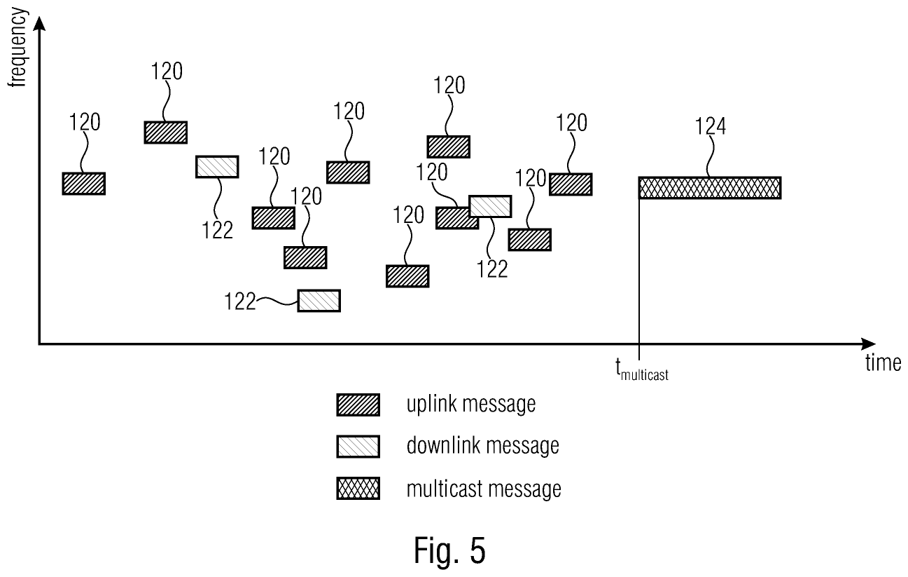

For example, this could be implemented as shown in FIG. 5, wherein, during the emission of the multicast message (point-to-multipoint data transfer) 124, advantageously, there are no other data transfers (e.g. overlapping/overlaying the point-to-multipoint data transfer 124) (e.g. uplink data transfers 120 and/or downlink data transfers 122).

In detail, FIG. 5 shows, in a diagram, an occupancy of a frequency band of the communication system 100 when performing several uplink data transfers 120 and downlink data transfers 122 between the base station 104 and several of the participants 106_1-106_n, and a point-to-multipoint data transfer 124 from the base station 104 to several of the participants 106_1-106_n, according to an embodiment of the present invention. In FIG. 5, the ordinate describes the frequency, and the abscissa describes the time. In other words, FIG. 5 shows an example of a multicast message (point-to-multipoint data transfer) 124 in an uncoordinated communication system.

For the participants 106_1-106_n, or a subset of the participants 106_1-106_n, of the communication system 100 to receive such a multicast message (point-to-multipoint data transfer) 124 according to FIG. 5, in embodiments, signaling of the point in time t_{multicast} of the point-to-multipoint data transfer 124 or of other information based on which the participants 106_1-106_n may receive the point-to-multipoint data transfer 124 is carried out, as explained in the following.

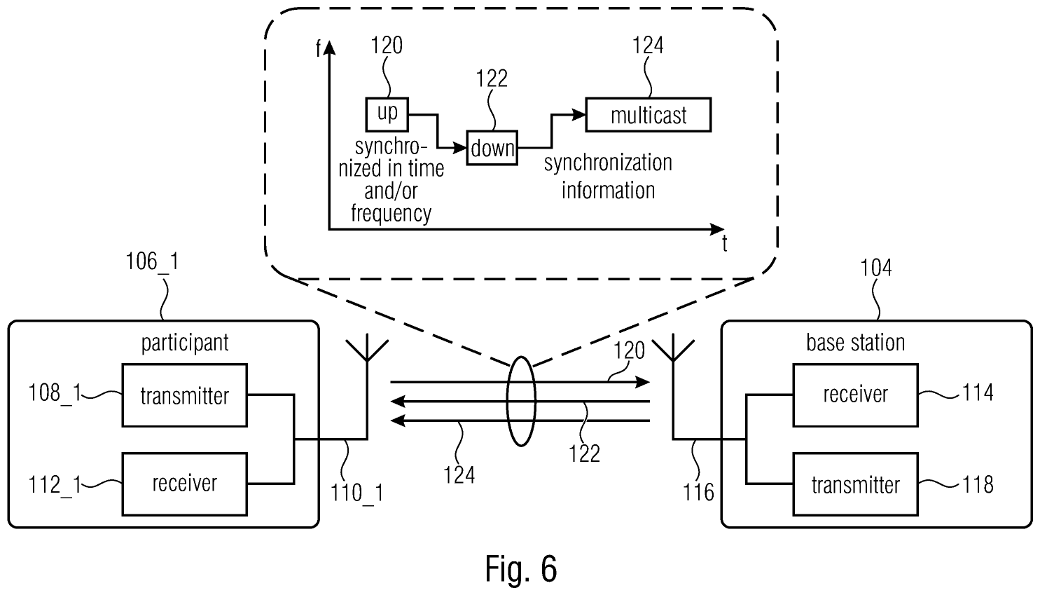

FIG. 6 shows a schematic block circuit diagram of a participant 106_1 and a base station 104, according to an embodiment of the present invention.

The participant 106_1 (e.g. terminal point) may be configured to transmit data uncoordinatedly with respect to the base station 104 and/or other participants of the communication system 100 (cf. FIG. 3).

Furthermore, the participant 106_1 may be configured to transmit an uplink data transfer 120 to the base station 104, and to receive, temporally synchronized to the uplink data transfer 120, a downlink data transfer 122 from the base station 104, wherein the downlink data transfer 122 comprises signaling information, wherein the signaling information indicates, or signals, a subsequent point-to-multipoint data transfer 124 of the base station 104 and/or a further data transfer (e.g. a data transfer preparing the point-to-multipoint data transfer) preceding the point-to-multipoint data transfer 124.

Furthermore, the participant 106_1 may be configured to receive the point-to-multipoint data transfer (e.g. the multicast data transfer) 124 from the base station 104 on the basis of the signaling information.

The base station 104 may be configured to receive the uplink data transfer 120 from the participant 106_1 and to transmit, temporally synchronized to the received uplink data transfer 120, the downlink data transfer 122 to the participant 106_1, wherein the downlink data transfer 122 comprises the signaling information, wherein the signaling information indicates, or signals, the subsequent point-to-multipoint data transfer 124 of the base station 104 and/or the further data transfer (e.g. the data transfer preparing the point-to-multipoint data transfer) preceding the point-to-multipoint data transfer 124.

Furthermore, the base station 104 may be configured to transmit the point-to-multipoint data transfer 124 to the participant 160 (and to one or several other participants of the communication system 100, for example) according to the signaling information.

In embodiments, the signaling information may comprise information about a point in time of the point-to-multipoint data transfer 124. For example, the information about the point in time may be an absolute point in time, a relative point in time (e.g. a defined time span between the downlink data transfer 122 and the point-to-multipoint data transfer 124), or information from which the absolute or relative point in time may be derived, such as a number of clock cycles of a clock generator (oscillator) of the participant.

In embodiments, the signaling information may additionally or alternatively comprise information about a frequency or a frequency channel (e.g. of the frequency band used by the communication system) of the point-to-multipoint data transfer 124. For example, the information about the frequency may be an absolute frequency, or a relative frequency (e.g. an interval between a frequency of the downlink data transfer 122 and a frequency of the point-to-multipoint data transfer 124). For example, the information about the frequency channel may be an absolute frequency channel, or a relative frequency channel (e.g. a distance between a frequency channel of the downlink data transfer 120 and a frequency channel of the point-to-multipoint data transfer 124).

In embodiments, the point-to-multipoint data transfer 124 may comprise a plurality of sub-data packets transmitted distributed in time and frequency according to a time and/or frequency hopping pattern (telegram splitting transfer method). In this case, the signaling information may further comprise information about the time and/or frequency hopping pattern of the point-to-multipoint data transfer 124. For example, the point-to-multipoint data transfer 124 may be a telegram splitting-based data transfer. In a telegram splitting-based data transfer, the data to be transferred (e.g. (encoded) payload data of the physical layer) is divided onto a plurality of sub-data packets so that the plurality of sub-data packets each comprise only a part of the data to be transferred, wherein the plurality of sub-data packets is transferred not continuously, but distributed in time and/or frequency according to a time and/or frequency hopping pattern.

Detailed embodiments of the participant 106_1 and the base station 104 are described in more detail in the following.

### 1.1 Signaling in the Previous Downlink Packet

Beside messages targeted to several participants 106_1-106_n, the base station 104 typically also transfers individual information to the participants 106_1-106_n, e.g. an authenticated confirmation or a change of parameters of the respective participant. Since this is individual to each participant, an individual downlink has to be transferred.

This is where embodiments of the present invention come into place, by attaching the point in time of transmission of the following multicast message (point-to-multipoint data transfer) 124 to the individually transferred downlink message (downlink data transfer) 122.

If there are several frequency channels available, beside the signaling of the transmission time, the information about the transmission channel may also be added (e.g. signaled).

By this signaling, a participant now knows the point in time, and possibly the frequency channel, of the upcoming multicast message (point-to-multipoint data transfer) 124. With the help of the same method, further participants may also be synchronized to the multicast message (point-to-multipoint data transfer) 124.

If there is no individual data to be transmitted to the participant, only the point in time and, possibly, the frequency channel may be transferred in the upcoming downlink message (downlink data transfer) 124 in this case.

This method has the advantage that the point in time and, possibly, the frequency channel is only shared with the participants (the plurality of participants 106_1-106_n of the communication system 100) that are to receive the multicast message (point-to-multipoint data transfer) 124. Thus, for the participants that are not to receive the multicast message (point-to-multipoint data transfer) 124, there is no additional effort that increases the battery consumption.

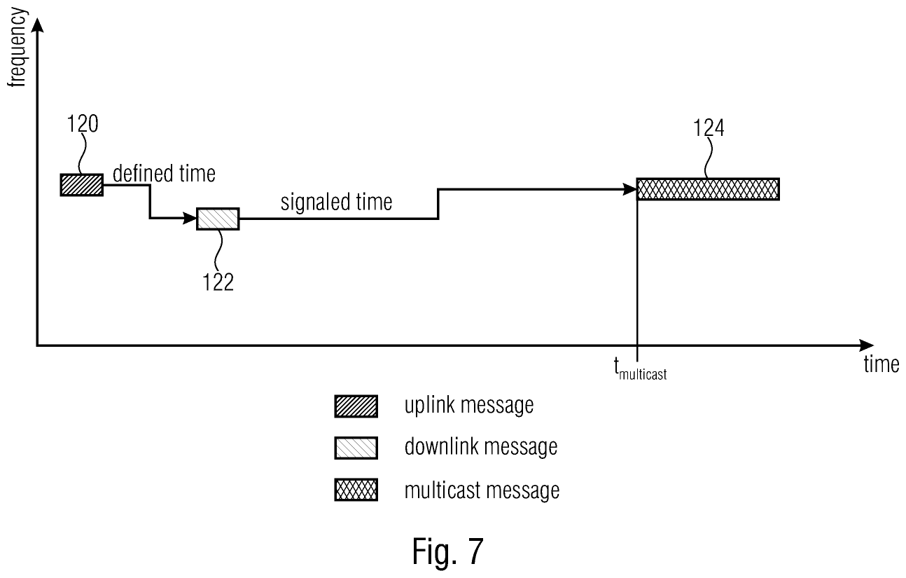

FIG. 7 exemplarily shows the process of the signaling of the multicast message (point-to-multipoint data transfer) 124 from the uplink message (uplink data transfer) 120 to the actual multicast message (point-to-multipoint data transfer) 124 for one participant of an uncoordinated radio network (communication system) 100.

In detail, FIG. 7 shows, in a diagram, an occupancy of the frequency band of the communication system 100 when performing an uplink data transfer 120, a downlink data transfer 122, and a point-to-multipoint data transfer 124, according to an embodiment of the present invention. In FIG. 7, the ordinate describes the frequency, and the abscissa describes the time.

As can be seen in FIG. 7, the downlink data transfer 122 takes place temporally synchronized to the uplink data transfer 120, e.g. after a specified (defined) time after the uplink data transfer 120. The downlink data transfer 122 comprises signaling information that indicates, or signals, the subsequent point-to-multipoint data transfer 124.

As indicated in FIG. 7, the signaling information may comprise information about a point in time of the point-to-multipoint data transfer 124, for example. Obviously, the signaling information may also additionally or alternatively comprise information about a frequency or a frequency channel of the point-to-multipoint data transfer 124.

In embodiments, if the point-to-multipoint data transfer 124 is transferred on the basis of the telegram splitting transfer method (TSMA, telegram splitting multiple access), the signaling information may comprise information about the time and/or frequency hopping pattern of the point-to-multipoint data transfer 124.

In other words, if TSMA is used for the transfer of the multicast message (point-to-multipoint data transfer) 124, the hopping pattern (time and/or frequency hopping pattern) may be signalized in addition if this has not been defined globally in advance.

In embodiments, the information about the point in time of transmission and/or transmission channel (transmission frequency) and/or the hopping pattern (only in TSMA) may be attached to an individually generated downlink data packet (e.g. the downlink data transfer 120) to a participant.

[4] defines a so-called authenticated wakeup message and/or authentication message in the downlink. With the help of this message, the base station 104 may transmit individually to a participant a confirmation of the preceding uplink message. If further individual data for the participant is available, the length of this data and the interval between the message and the following data is also signaled in this message. Now, if there is a signaling of a multicast message to a participant and there is no further individual data for the participant, the additional transfer may be used for the signaling of the multicast message, beside the wakeup message and authentication message.

In case of signaling a multicast message (point-to-multipoint data transfer) 124 only, the fields containing the additional information for the following data (length and time information, or PSI and TSI in [4]) may also be used for the direct signaling of the multicast message (point-to-multipoint data transfer) 124 (time, frequency, length, etc.). This reduces the overhead that would be required for the separate transfer beside the wakeup and authentication message.

In embodiments, in case of signaling a multicast message (point-to-multipoint data transfer) 124 only, available fields in a wakeup message and/or authentication message (downlink data transfer according to [4]) can be used to this end.

### 1.2 Rough Time Signaling

According to section 1.1, it often takes a long time until all necessary participants have been informed about the upcoming multicast message (point-to-multipoint data transfer) 124. Particularly in case of participants that have been informed about the upcoming multicast message (point-to-multipoint data transfer) 124 very early, a very large time difference has to be signaled. Being able to resolve this in an appropriately fine manner requires many bits to be transferred. In case of participants that are informed (temporally) very close to the actual multicast message (point-to-multipoint data transfer) 124, in the case of the same resolution, the upper spots of the bits of the data field are zero in the signaling.

From this follows that, depending on the (temporal) difference between the signaling and the multicast message (point-to-multipoint data transfer) 124, a sequence of different length would make sense for the signaling.

However, when considering a real participant that comprises a quartz, it becomes apparent that the inaccuracy of the point in time when the participant expects the multicast message (point-to-multipoint data transfer) 124 also depends on the time difference between the signaling and the multicast message (point-to-multipoint data transfer) 124.

The longer the difference, the more inaccurate is the point in time which the participant assumes for the multicast message (point-to-multipoint data transfer) 124. The more inaccurate this point in time, the larger the search range for the multicast message (point-to-multipoint data transfer) 124 that the participant selects. If the search range is significantly larger than the resolution of the transferred point in time of the multicast message (point-to-multipoint data transfer) 124, the resolution may be selected to be lower (thus more uncertainty), without drastically increasing the search range (in the worst case, the quartz error and the resolution error add up).

Typical values for inaccuracy in the signaling are in the range of 1 symbol (e.g. symbol durations) to ten 10,000 symbols (symbol durations).

Values higher than 10,000 symbols (e.g. symbol durations) have too large an inaccuracy and would require a very extensive post-synchronization.

In the case of ideal timings, it is important to note that the uncertainty is still large enough that a reception without post-synchronization would not be possible.

In embodiments, the resolution of the signaling may comprise a certain inaccuracy that may be determined in the context of the post-synchronization.

Instead of or in combination with the rough signaling of the point in time, a non-linear scaling of the point in time may be selected, e.g. a logarithmic scaling. This has the advantage that points in time close to the upcoming multicast message (point-to-multipoint data transfer) 124 have a more precise resolution than points in time still farther away. According to the above explanations, however, this is not critical since the inaccuracies increase as a (temporal) interval to the multicast message (point-to-multipoint data transfer) 124 increases due to quartz offsets (e.g. frequency offsets of the quartzes). Thus, the resolution may accordingly also become more inaccurate, the farther the point in time of the multicast message (point-to-multipoint data transfer) 124 is in the future.

In embodiments, the resolution of the signaling may comprise a non-linear scaling.

1.3 Signaling of a Further Uplink Message

For the signaling of the point in time of the multicast message (point-to-multipoint data transfer) 124 according to section 1.1 or section 1.2, e.g., one variable with 16 bits is typically transferred. In case of an exemplarily selected quantization of 1 s per LSB (Least Significant Bit), there is a maximum difference between the signaling and the multicast message (point-to-multipoint data transfer) 124 of 65536 seconds. This is approximately 18 hours.

Thus, it should be ensured that all required participants for the multicast message (point-to-multipoint data transfer) 124 can be informed within 18 hours before the message.

Typically, in large networks with several hundreds of thousands of participants (e.g. nodes) 106_1-106_n, this cannot be realized since there may be participants that transfer data to the base station 104 only once a day or even more infrequently. Thus, with the above-mentioned parameters, it is not possible to inform all participants (e.g. nodes) about the upcoming multicast message (point-to-multipoint data transfer) 124, or to signal the same to them.

Thus, in embodiments, instead of the point in time of the multicast message (point-to-multipoint data transfer) 124, an (approximate) time at which the participants should/have to transmit an uplink message (uplink data transfer) 120 to the base station 104 again may be shared with all participants informed about the multicast message (point-to-multipoint data transfer) 124 temporally before the maximum signaling length.

If this new uplink message (uplink data transfer) 120 is emitted by the participant, the base station 104 may in turn send back a downlink message (downlink data transfer) 122 and inform in the same about the point in time of the multicast message (point-to-multipoint data transfer) 124.

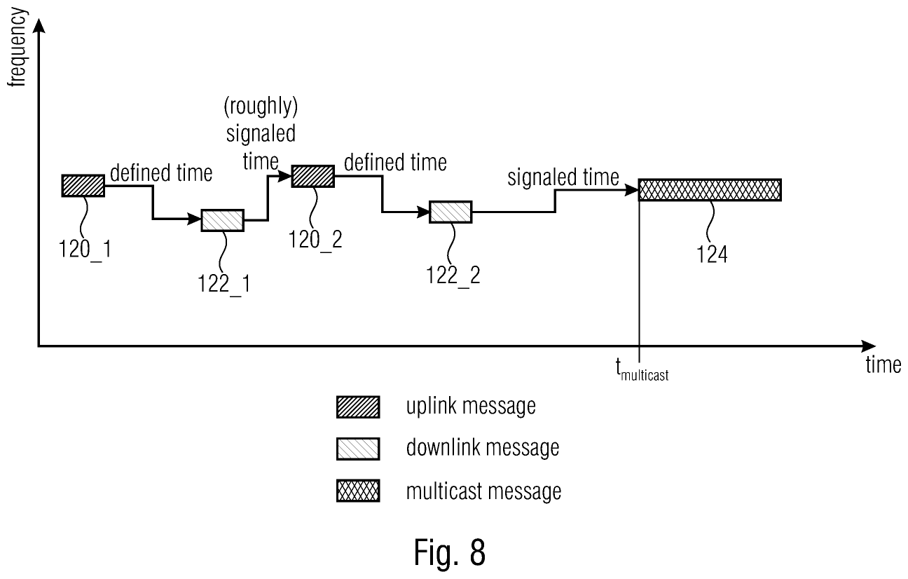

The temporal sequence of this schema is illustrated in FIG. 8. In this case, a (rough) time for a further uplink message (second uplink data transfer) 120_2 was transferred in the first downlink message (first downlink data transfer) 122_1. The information about the point in time and/or the frequency for the multicast message (point-to-multipoint data transfer) 124 then followed in the second downlink message (second downlink data transfer) 122_2.

In detail, FIG. 8 shows, in a diagram, an occupancy of the frequency band of the communication system 100 when performing a first uplink data transfer 120_1, a first downlink data transfer 122_1, a second uplink data transfer 120_1, and a second downlink data transfer 122_2, as well as a point-to-multipoint data transfer 124, according to an embodiment of the present invention. In FIG. 8, the ordinate describes a frequency, and the abscissa describes the time.

As can be seen in FIG. 8, the first downlink data transfer 122 takes place temporally synchronized to the first uplink data transfer 120_1, e.g. after a specified (defined) time after the first uplink data transfer 120_1. The first downlink data transfer 122 comprises first signaling information.

The first signaling information may indicate, or signal, a further data transfer (e.g. the data transfer preparing the point-to-multipoint data transfer) preceding the point-to-multipoint data transfer 124, wherein, in the embodiment shown in FIG. 8, the further data transfer may include both the second uplink data transfer 120_2 and the second downlink data transfer 122_2 following the same temporally synchronized.

As indicated in FIG. 8, the first signaling information may signal a timespan or point in time (e.g. a rough point in time) for the second uplink data transfer 120_2, wherein the second uplink data transfer 122_2 takes place in the time span, or at the rough point in time, signaled with the first signaling information, and wherein the second downlink data transfer 122_2 takes place temporally synchronized to the second uplink data transfer 120_2, e.g. after a specified (defined) after the first uplink data transfer 120_1. The second downlink data transfer 122_2 may comprise second signaling information, wherein the second signaling information indicate, or signal, the subsequent point-to-multipoint data transfer 124 of the base station 104.

For example, as indicated in FIG. 8, the second signaling information may comprise information about a point in time of the point-to-multipoint data transfer 124. Obviously, the second signaling information may additionally or alternatively also comprise information about a frequency or a frequency channel of the point-to-multipoint data transfer 124. If the point-to-multipoint data transfer 124 is transferred on the basis of the telegram splitting transfer method (TSMA, Telegram Splitting Multiple Access), the second signaling information may additionally or alternatively also comprise information about the time and/or frequency hopping pattern of the point-to-multipoint data transfer 124.

In other words, FIG. 8 shows a signaling of a time for a further uplink message (e.g. a second uplink data transfer) 120_2, wherein the further uplink message (e.g. the second uplink data transfer) 120_2 is followed by a further downlink message (e.g. a second downlink data transfer) 122_2 that defines a time for the multicast message (e.g. point-to-multipoint data transfer) 124, for example.

If a participant transmits messages to the base station 104 even more infrequently, e.g. only once per week, is also possible to request a further uplink message (uplink data transfer) multiple times as long as the required time for the signaling is within the valid range.

In embodiments, instead of the signaling of the point in time of the multicast message (point-to-multipoint data transfer), a (rough, approximate) time at which the participant should/has to send a further uplink message may be defined.

Due to the missing coordination of the communication system (radio network) 100, there may be interferences and failures in the transfer. The communication system 100 described herein is often operated in license-free bands in which the communication system 100 shares the resources with other communication systems (c.f. FIG. 3), wherein the communication system 100 and the other communication systems are mutually uncoordinated. Thus, there may also be interferences due to third-party communication systems.

With the telegram splitting transfer method, an approach that comprises a very high interference robustness has been developed, however, a maximum probability of getting through cannot be guaranteed.

If a participant has been informed about a further emission of an uplink message (uplink data transfer) according to section 1.3, the participant may expect a reliable answer of the base station 104 in the downlink (e.g. in the form of a downlink data transfer).

However, if the participant does not receive a downlink message (downlink data transfer) or a wrong/faulty/destroyed one, the participant knows that something in the transfer has not gone correctly (e.g. due to an interference in the channel).

In this case, the participant may promptly transmit a further uplink message (e.g. a third uplink data transfer) (e.g. a repetition of the previous uplink message (e.g. the second uplink data transfer 120_2)) to the base station 104. Then, it waits for the downlink message (e.g. the third downlink data transfer) of the base station 104 again. If this is received correctly again, it is ensured that the uplink message (e.g. the third uplink data transfer) has now correctly arrived at the base station 104. Otherwise, the participant may open a further reception window (e.g. for a further downlink data transfer) (if this is known to the base station 104) or carry out another emission of an uplink message (uplink data transfer).

In embodiments, if no correct answer in the downlink (e.g. in the form of a second downlink data transfer) has been obtained to the temporally (roughly) signaled further uplink message (e.g. the second uplink data transfer), a further uplink message (e.g. a third uplink data transfer) may be emitted (promptly).

Alternatively to signaling the multicast message (point-to-multipoint data transfer) 124, the point in time of the multicast message (point-to-multipoint data transfer) 124 may still be shared, however, with another resolution (e.g. a range of 1 minute to 1.5 months). The participant may then decide itself when (before the multicast message (point-to-multipoint data transfer) 124) it transmits an uplink message (e.g. a fourth uplink data transfer) again to obtain the more precise point in time (of the point-to-multipoint data transfer 124).

Through this, the participant may wait, e.g., up to 1 hour before the multicast message (point-to-multipoint data transfer) 124 whether an uplink message (uplink data transfer) is required anyway, and it thus obtains the precise point in time. If this is not the case, the participant may transmit a dedicated uplink message (e.g. the fourth uplink data transfer). In this case, the dedicated uplink message (e.g. the fourth uplink data transfer) should obviously be placed (pseudo-)randomly in the remaining time so that not all of the participants (e.g. nodes) not having a precise time synchronization for the multicast message (point-to-multipoint data transfer) 124 transmit at once.

In embodiments, in the case of participants that were informed long before the actual multicast message, the resolution may be selected to be larger in the signaling of the point in time. Then, for the time being, the participant may wait until shortly before the multicast message (point-to-multipoint data transfer) 124 whether there has been an uplink message (uplink data transfer). If this is not the case, a dedicated uplink message (e.g. the fourth uplink data transfer) may be triggered.

1.4 Signaling of the Time and/or the Frequency Channel of a Support Beacon

In embodiments, prior to the transfer of a multicast message (point-to-multipoint data transfer) 124, a so-called support beacon may be employed. Such a support beacon may contain a signaling until the next support beacon, or until the multicast message (point-to-multipoint data transfer) 124.

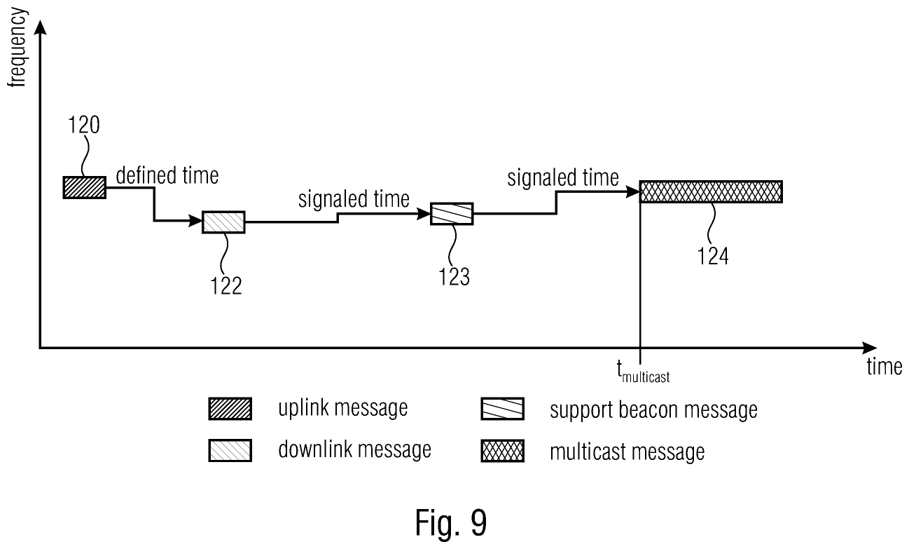

In embodiments, the participants (of the communication system 100) may be synchronized to this support beacon. In the same way as in section 1.1, e.g., the time until the support beacon and possibly the frequency channel of the support beacon used may be signaled, as is schematically indicated in FIG. 9.

FIG. 9 shows, in a diagram, an occupancy of the frequency band of the communication system 100 when performing an uplink data transfer 120, a downlink data transfer 122, and a point-to-multipoint data transfer 124, according to an embodiment of the present invention. In FIG. 9, the ordinate describes the frequency, and the abscissa describes the time.

As can be seen in FIG. 9, the downlink data transfer 122 takes place temporally synchronized to the uplink data transfer 120, e.g. after a specified (defined) time after the uplink data transfer 120. The downlink data transfer 122 comprise first signaling information.

The first signaling information may indicate, or signal, a further data transfer (e.g. the data transfer preparing the point-to-multipoint data transfer) preceding the point-to-multipoint data transfer 124, wherein in the embodiment shown in FIG. 9, the further data transfer is a support beacon 123.

As is indicated in FIG. 9, the first signaling information may comprise information about a point in time of the support beacon 123. Obviously, the first signaling information may additionally or alternatively also comprise information about a frequency or a frequency channel of the support beacon. If the support beacon 123 is transferred on the basis of the telegram splitting transfer method (TSMA, Telegram Splitting Multiple Access), the first signaling information may additionally or alternatively also comprise information about the time and/or frequency hopping pattern of the support beacon 124.

The support beacon may comprise second signaling information, wherein the second signaling information indicates, or signals, a further support beacon or the subsequent point-to-multipoint data transfer 124 of the base station 104.

For example, as is indicated in FIG. 9, the second signaling information may comprise information about a point in time of the point-to-multipoint data transfer 124. Obviously, the second signaling information may additionally or alternatively also comprise information about a frequency or a frequency channel of the point-to-multipoint data transfer 124. If the point-to-multipoint data transfer 124 is transferred on the basis of the telegram splitting transfer method (TSMA, Telegram Splitting Multiple Access), the second signaling information may additionally or alternatively also comprise information about the time and/or frequency hopping pattern of the point-to-multipoint data transfer 124.

In other words, FIG. 9 shows a signaling of the time and possibly the frequency offset from a message of a participant (downlink data transfer 120) to a support beacon 123.

In embodiments, the information about the transmission time and/or transmission channel (transmission frequency) and/or hopping pattern (only in case of TSMA) of a support beacon may be added to an individually generated downlink data packet (e.g. a downlink data transfer 120) to a participant.

### 1.5 Compensation of Quartz Offsets

As already mentioned in section 1.2, the participants 106_1-106_n and the base station 104 usually have oscillation quartzes (e.g. as clock generators) for generating internal reference frequencies. However, these quartzes are not ideal and have so-called tolerances on the available frequencies. These tolerances are also transferred to the internal reference frequencies.

Among other things, the transmission frequency and the timer are fed from these reference frequencies, determining the time differences between the messages. Thus, the tolerances of the quartz directly affect the transfer and the reception of messages.

For example, the reception frequency of a participant is estimated in [4] from the uplink message (uplink data transfer), and the transmission frequency in the downlink is modified such that the participant may receive the downlink message (downlink data transfer) without a frequency offset. In other words, the characteristics of the downlink message (downlink data transfer) are adapted according to the frequency offset (of the quartz) of the participant such that the participant does no longer see the frequency offset of the quartz.

This schema works perfectly as a long as there is only communication between one base station 104 and one participant 106_1. If a base station 100 communicates with two or more participants 106_1-106_n, the base station 104 obtains for each one of the participants 106_1-106_n a different frequency offset generated by the respective quartz.

Thus, it is not possible to send a multicast message (point-to-multipoint data transfer) 124 to all participants 106_1-106_n in such a way that all participants 106_1-106_n do not see any or only a negligibly low frequency offset and/or time offset by their quartz.

Due to its admissible tolerances, each participant (e.g. node) has to carry out a time and frequency synchronization at the start of the multicast message (point-to-multipoint data transfer) 124.

Starting from a typical oscillation quartz with a tolerance range of 20 ppm and the maximum signaling length of approximately 18 hours, as exemplarily shown in section 1.3, there is a maximum temporal inaccuracy of the participant at the point in time of transfer of the multicast message (point-to-multipoint data transfer) 124 of 65536 s*20 ppm=1.31 s. Thus, for the correct point in time, the participant has to search through a search range of ±1.31 s before and after the expected point in time of the multicast message (point-to-multipoint data transfer) 124.

The same applies to the frequency offset, in case of a typical carrier frequency of 900 MHz, the maximum offset that has to be searched by the respective participant is ±18 kHz.

If the participant has fast processors for a search in real time, it may determine the correct point in time and the frequency offset without large storage requirements. However, if the search cannot be carried out in real time, all baseband data may alternatively be stored for a subsequent offline evaluation.

In the second case, the participants typically only have very small microprocessors on which a full storage of the baseband data is not possible with such large inaccuracies.

Consider the following example: the data rate of the multicast message (point-to-multipoint data transfer) 124 is 5 KHz. In case of the above-mentioned quartz offset of 20 ppm, the bandwidth to be searched is therefore 2*18 kHz+5 kHz=41 kHz. Thus, when using a SDR frontend in the baseband (I-phase and Q-phase), the sample rate is also at least 41 ksamples/s. Thus, in the above-mentioned search range of ±1.31 seconds, it has to be possible to buffer 107,420 samples in the memory for processing. With a typical ADC resolution of 16 bits (I-phase of 16 bits and Q-phase of 16 bits), this requires a random access memory of at least 429,680 kilobytes. Typical values for random access memories on small microprocessors are below 100 kilobytes (e.g. 64 kilobytes). Thus, offline processing of the entire search range cannot be carried out.

Both cases additionally require a very high computational effort, therefore significantly increasing the current consumption, which is particularly critical in battery-operated participants.

Thus, large search ranges both in the time direction and the frequency direction have to be avoided.

In some systems, the participants also have more than one quartz, e.g. a LF quartz (LF=low frequency) and a HF quartz (HF=high frequency). The LF quartz usually requires less current than the HF quartz. Thus, the LF quartz is usually operated continuously, and the timings are derived therefrom. However, the radio chip needs a higher clock, and is therefore operated with the HF quartz. Thus, the transmission frequency depends on the HF quartz. For reasons of the current consumption, the HF quartz can be turned off between the emissions.

The LF quartz typically has a higher tolerance than the HF quartz. For example, the LF quartz may have a tolerance of 100 ppm, whereas the HF quartz may have a tolerance of 20 ppm, for example.

As already mentioned, a measurement/estimation of the carrier frequency is carried out in [4]. The frequency offset may be determined with the help of the expected carrier frequency, and the quartz error may be determined therefrom. Alternatively or in combination with the estimation of the carrier frequency, it would also be possible to measure the time intervals (between two telegrams/packets/emissions or within one emission in the case of telegram splitting) so as to estimate the deviation of the quartz.

This offset, or these offsets, may also be transferred in the downlink (i.e. with the downlink data transfer) together with the parameters from the previous sections 1.1 to 1.4. As a result, the participant now knows its quartz offset at the point in time of the emission of the uplink message (uplink data transfer).

Alternatively, the average quartz offset from several previous uplink messages (uplink data transfers) may be used, and/or the temperature dependency could also be considered (informing about the temperature-normalized frequency deviation) if the temperature should be available.

When using the method of the quartz offset determination through the time offset, the accumulated offset (e.g. time offset) may also be determined. Here, the base station 104 knows the time between two arbitrary emissions (e.g. uplink data transfers) (i.e. not necessarily two successive emissions). Now, the base station 104 receives the two emissions (e.g. uplink data transfers) and determines the temporal deviation between the emissions (e.g. uplink data transfers). From this, the accumulated quartz offset (e.g. time offset) may be determined. Thus, the deviations of the quartz due to temperature deviations during the time between the two emissions (e.g. uplink data transfers) are therefore accumulated, since the quartz has to run continuously so as to determine the points in time of transmission, and the current environmental conditions therefore have an influence on the quartz.

The situation is different if the quartz offset is determined through the transmission frequency, since only the offset (e.g. frequency offset) at the current transmission point in time has an influence on the transmission frequency.

Typically, the environmental conditions at the respective participant do not change immediately, so that one can assume that, if the current quartz offset (e.g. frequency offset of the quartz) is known, the maximum error across the time between the signaling of the multicast message (point-to-multipoint data transfer) 124 and the actual emission (of the point-to-multipoint data transfer 124) is smaller than the maximum admissible quartz offset.

This reduces the search range both in the time direction and the frequency direction, therefore saving computational power, storage space and also energy. When selecting the same parameters as in the previous example, with the exception of the quartz offset in the respective participant having been corrected on the basis of the value from the previous uplink message (uplink data transfer) in this case, the maximum possible remaining offset (e.g. remaining frequency offset) is reduced to 5 ppm, for example.

Thus, the maximum search range in the time direction is reduced to 328 ms, or to 4.5 kHz in the frequency direction. Thus, only a quarter of the storage space is necessary, and the computational power is also reduced by this factor.

If more than one quartz is installed in the respective participants, the base station 104 may accordingly also determine the offset (e.g. frequency offset) for several quartzes, and signal the same (e.g. in the downlink data transfer). Alternatively, the quartzes may also be coupled in the participant (e.g. the node). As a result, (e.g. all of) the quartzes (of the respective participant) have the same offset (e.g. frequency offset). In this case, it is sufficient if the base station 104 estimates only the offset (e.g. frequency offset) of one quartz, since the respective participant may directly apply the offset to the other quartzes.

In embodiments, the quartz offset of the participant may be determined from the uplink message (uplink data transfer), and the participant may be informed about the same in the following downlink message (downlink data transfer). The participant may correct this offset and accordingly select smaller search windows when receiving the multicast message (point-to-multipoint data transfer).

Alternatively to signaling the quartz offset (e.g. frequency offset of the quartz) from the uplink (e.g. the uplink data transfer), the base station 104 may also use the quartz offset to adapt the signaled point in time of the multicast message (point-to-multipoint data transfer). To this end, the base station 104 may calculate the deviation of the point in time under consideration of the quartz offset of the participant (e.g. the terminal point) and accordingly signal the “wrong”, or corrected, point in time. This similarly applies to the signaling of the frequency channel and, if applicable, of the hopping pattern in the case of telegram splitting.

Thus, the participant does not have to know anything about its quartz offset and may assume a smaller quartz error (see above) when searching for the start of the multicast message (point-to-multipoint data transfer).

In embodiments, the quartz offset (e.g. frequency offset of the quartz) of the participant may be considered when signaling the start time (e.g. of the point-to-multipoint data transfer 124) and may be modified in the base station 104 accordingly.

### 2. Support Beacons

The embodiments described in the following concern multicast/broadcast transfers (point-to-multipoint data transfers to a real subset of or to all participants) in radio systems with non-coordinated participants. In particular, embodiments for synchronizing and/or maintaining synchronization of the participants prior to a multicast/broadcast transfer are described.

On the basis of the embodiments described in section 1, there is a larger uncertainty in the time synchronization in case of larger time offsets between a synchronization of a participant (signaling of the multicast/broadcast message) and the multicast/broadcast transfer. However, it may be desirable to synchronize participants across a longer time span, e.g., so as to also reach with the multicast/broadcast transfer participants with a lower frequency of transmission.

This problem may be solved by using support beacons. To this end, section 1 already described the synchronization to a support beacon. The subsequent embodiments refer to implementations of the support beacons.

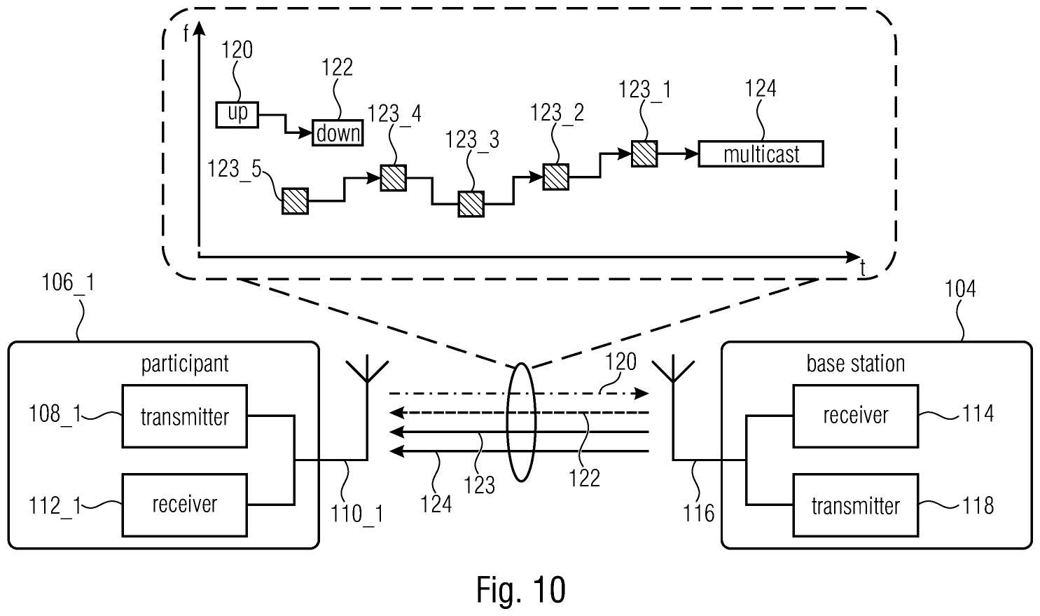

FIG. 10 shows a schematic block circuit diagram of a participant 106_1 and a base station 104, according to an embodiment of the present invention.

The participant 106_1 (e.g. the terminal point) may be configured to transmit data uncoordinatedly with respect to the base station 104 and/or other participants of the communication system 100 (cf. FIG. 3).

Furthermore, the participant 106_1 may be configured to receive a support beacon 123_1 or several (e.g. at least two) support beacons 123_1-123_4 of a plurality of support beacons 123_1-123_m of the base station 104, wherein the one support beacon 123_1 or the several support beacons 123_1-123_4 comprise synchronization information, and to receive a point-to-multipoint data transfer 124 of the base station 104 on the basis of the synchronization information.

The base station 104 may be configured to emit a support beacon 123_1 or a plurality of support beacons 123_1-123_m, wherein the one support beacon 123_1 or the plurality of support beacons 123_1-123_m comprise synchronization information for synchronizing uncoordinatedly-transmitting participants of the communication system 100, wherein the base station 104 is configured to transmit the point-to-multipoint data transfer 124.

In embodiments, the participant 106_1 may be configured to receive (precisely) one support beacon 123_1 from the base station 104, and to receive the point-to-multipoint data transfer 124 of the base station 104 on the basis of the synchronization information contained in the support beacon 123_1.

For example, the synchronization information of the support beacon 123_1 may comprise information about a point in time (e.g. an absolute or relative point in time, such as a time interval with respect to the support beacon 123_1) of the point-to-multipoint data transfer 124. Additionally (or alternatively), the synchronization information of the support beacon 123_1 may comprise information about a frequency channel (e.g. an absolute or relative frequency channel, such as a frequency channel interval with respect to a frequency channel of the support beacon 123_1) of the point-to-multipoint data transfer 124. Additionally (or alternatively), the synchronization information of the support beacon 123_1 may comprise information about a time and/or frequency hopping pattern on the basis of which the point-to-multipoint data transfer is transferred. On the basis of the information about a point in time and/or a frequency channel and/or a hopping pattern of the point-to-multipoint data transfer 124 (e.g. with respect to, or relative to, the support beacon 123_1) the participant 106_1, actually transmitting uncoordinatedly (and asynchronously) with respect to the base station 104, may receive the point-to-multipoint data transfer 124 of the base station 104.

For example, the synchronization information of the support beacon 123_1 may comprise a synchronization sequence for synchronizing the participant 106_1 to the support beacon 123_1, wherein the participant 106_1 may be configured to synchronize itself to the respective support beacon on the basis of the synchronization sequence. As a result, form example, the participant 106_1 may know a (relative) point in time and/or a (relative) frequency channel, or a (relative) frequency of the support beacon 123_1. On the basis of the (relative) point in time and/or the (relative) frequency channel, or the (relative) frequency of the support beacon 123_1 and information about a point in time and/or a frequency channel and/or a hoping pattern of the point-to-multipoint data transfer 124 (e.g. with respect to, or relative to, the support beacon 123_1), e.g., which may be contained in the synchronization information of the support beacon 123_1 or which may be derived from information transferred with the support beacon 123_1 or which may be known to the participant 106_1 in another way (e.g. from a preceding downlink data transfer 122), the participant 106_1, actually transmitting uncoordinatedly (and asynchronously) with respect to the base station 104, may receive the point-to-multipoint transfer 124 of the base station 104.

In embodiments, the participant 106_1 may be configured to receive several (e.g. at least two) support beacons 123_1-123_4 from the base station 104, and to receive the point-to-multipoint data transfer 124 of the base station 104 on the basis of the synchronization information contained in the support beacons 123_1-123_4.

The embodiment shown in FIG. 10 exemplarily assumes that five support beacons 123_1-123_m (m=5) are emitted by the base station 104. Furthermore, FIG. 10 exemplarily assumes that the support beacon 123_1 is emitted prior to the point-to-multipoint data transfer 124 (e.g. that the support beacon 123_1 is the last support beacon emitted prior to the point-to-multipoint data transfer 124), whereas the other support beacons are emitted at different points in time 123_2-123_5 prior to the support beacon 123_1.

In this case, the participant 106_1 may be configured to receive several (e.g. at least two) of the support beacons 123_1-123_m emitted by the base station 104, i.e. at least a part (e.g. a real subset) of the support beacons 123_1-123_m emitted by the base station 104, such as the support beacons 123_1-123_4.

In embodiments, the support beacons 123_1-123_m may each comprise synchronization information. In this case, the synchronization information of the support beacons 123_1-123_m may be identical or different.

In embodiments, the synchronization information may comprise information about:
a point in time (e.g. an absolute or relative point in time, such as a time interval with respect to the respective support beacon)) of the transfer of a further support beacon and/or the point-to-multipoint data transfer 124, and/or
a frequency channel (e.g. an absolute or relative frequency channel, such as a frequency channel interval with respect to a frequency channel of the respective support beacon) of the transfer of a further support beacon and/or the point-to-multipoint data transfer, and/or
a time and/or frequency hopping pattern on the basis of which a further support beacon and/or the point-to-multipoint data transfer is transferred.

For example, the synchronization information of one of the support beacons 123_2-123_5 (e.g. the support beacon 123_3), with the exception of the last support beacon 123_1, may comprise information about a point in time (e.g. an absolute or relative point in time, such as a time interval with respect to the respective support beacon) of the transfer of a further support beacon (e.g. the support beacon 123_2), or information about points in time of the transmission of several further support beacons (e.g. the support beacons 123_2 and 123_1). Additionally or alternatively, the synchronization information of one or several of the support beacons 123_2-123_5 (e.g. the support beacon 123_3), which the exception of the last support beacon 123_1, may comprise information about a point in time (e.g. an absolute or relative point in time such as a time interval with respect to the respective support beacon) of the transfer of the point-to-multipoint data transfer 124. The synchronization information of the last support beacon 123_1 may comprise information about a point in time (e.g. an absolute or relative point in time, such as a time interval with respect to the support beacon) of the transfer of the point-to-multipoint data transfer 124.

For example, the synchronization information of one of the support beacons 123_2-123_5 (e.g. the support beacon 123_3), with the exception of the last support beacon 123_1, may comprise information about a frequency channel (e.g. an absolute or relative frequency channel, such as a frequency channel interval with respect to a frequency channel of the respective support beacon) of the transfer of a further support beacon (e.g. the support beacon 123_2) or several further support beacons (e.g. the support beacons 123_2 and 123_1). Additionally or alternatively, the synchronization information of one or several of the support beacons 123_2-123_5 (e.g. the support beacon 123_3), with the exception of the last support beacon 123_1, may comprise information about a frequency channel (e.g. an absolute or relative frequency channel, such as a frequency channel interval with respect to a frequency channel of the respective support beacon) of the transfer of the point-to-multipoint data transfer 124. The synchronization information of the last support beacon 123_1 may comprise information about a frequency channel (e.g. an absolute or relative frequency channel, such as a frequency channel interval with respect to a frequency channel of the support beacon) of the transfer of the point-to-multipoint data transfer 124.

For example, the synchronization information of one of the support beacons 123_2-123_5 (e.g. the support beacon 123_3), with the exception of the last support beacon 123_1, may comprise information about a time and/or frequency hopping pattern on the basis of which one or several further support beacons (e.g. the support beacons 123_2 and 123_1) are transferred. Additionally or alternatively, the synchronization information of one or several of the support beacons 123_2-123_5 (e.g. the support beacon 123_3), with the exception of the last support beacon 123_1, may comprise information about a time and/or frequency hopping pattern on the basis of which the point-to-multipoint data transfer 124 is transferred.

The synchronization information of the last support beacon 123_1 may comprise information about a time and/or frequency hopping pattern on the basis of which the point-to-multipoint data transfer 124 is transferred.

On the basis of the signaling information contained in one or several support beacons (e.g. in the support beacon 123_3 or in the support beacons 123_4 and 123_3), it is possible for the participant 106_1, actually transmitting uncoordinatedly (and asynchronously) with respect to the base station 104, to receive one or several further support beacons (e.g. the support beacons 123_2 and 123_1) and, ultimately, the point-to-multipoint data transfer 124 of the base station 104.

In embodiments, (e.g. additionally or alternatively to the above embodiment) the synchronization information may comprise a synchronization sequence for synchronizing the participant 106_1 to the respective support beacon (e.g. to the support beacon 123_3), wherein the participant 106_1 may be configured to synchronize itself to the respective support beacon (e.g. the support beacon 123_3) on the basis of the synchronization sequence. For example, through the synchronization, the participant 106_1 may know a (relative) point in time and/or a (relative) frequency channel, or a (relative) frequency, of the respective support beacon (e.g. the support beacon 123_3). On the basis of the (relative) point in time and/or the (relative) frequency channel, or the (relative) frequency, of the respective support beacon (e.g. the support beacon 123_3) and information about a point in time and/or a frequency channel and/or a hoping pattern of one or several further support beacons (e.g. the support beacons 123_2 and 123_1), e.g., which may be contained in the synchronization information of the respective support beacon (e.g. the support beacon 123_3) or which may be derived from information transferred with the respective support beacon (e.g. the support beacon 123_3) or which is known to the participant 106_1 in another way (e.g. from a previous downlink data transfer 122), and information about a point in time and/or a frequency channel and/or a hopping pattern of the point-to-multipoint data transfer 124, e.g., which may be contained in the synchronization information of the respective support beacon (e.g. the support beacon 123_3) of the further support beacon (e.g. the support beacon 123_1) or that may be derived from information transferred with the respective support beacon (e.g. the support beacon 123_3) or a further support beacon (e.g. the support beacon 123_1) or which is known to the participant 106_1 in another way (e.g. from a previous downlink data transfer 122), the participant 106_1, actually transmitting uncoordinatedly (and asynchronously) with respect to the base station 104, may receive the point-to-multipoint data transfer 124 of the base station 104.

In embodiments, the support beacons 123_1-123_5 may be transferred in regular intervals or in intervals that are regular on average, wherein the participant 106_1 knows the intervals between the transfers of the support beacons 123_1-123_5, e.g. from a preceding downlink transfer 122 or a support beacon already received.

In embodiments, the support beacons 123_1-123_5 may be transferred at specified points in time and/or with specified time intervals and/or in specified frequency channels and/or in specified frequency channel intervals and/or according to a specified time hopping pattern and/or according to a specified frequency hopping pattern, wherein the participant 106_1 may be configured to receive the support beacons on the basis of the specified points in time and/or the specified time intervals and/or the specified frequency channels and/or the specified frequency channel intervals and/or the specified time hopping patterns and/or the specified frequency hopping patterns.

In embodiments, one or several (e.g. all) of the support beacons 123_2-123_5, with the exception of the last support beacon 123_1, may (e.g. each) comprise information about a transfer of a (e.g. respectively) subsequent support beacon, wherein the participant 106_1 may be configured to receive the (e.g. respectively) subsequent support beacon on the basis of the information about the transfer of the (e.g. respectively) subsequent support beacon.

For example, the support beacon 123_3 may comprise information about the transfer of the support beacon 123_2, wherein the participant 106_1 is configured to receive the support beacon 123_3 and to receive the support beacon 123_2 on the basis of the information about the support beacon 123_2 contained in the support beacon 123_3.

For example, the information about the transfer of the (e.g. respectively) subsequent support beacon may be a point in time and/or a time interval and/or a frequency channel and/or a frequency channel interval and/or a time hopping pattern and/or a frequency hopping pattern.

For example, the information about the transfer of the (e.g. respectively) subsequent support beacon may be contained in the synchronization information of the respective support beacons.

In embodiments, a point in time and/or a frequency channel of the transfer of one or several (e.g. each) of the support beacons 123_1-123_4, with the exception of the first support beacon 123_5, may be derived from information (e.g. CRC or support beacon counter) transferred with a preceding support beacon, wherein the participant 106_1 may be configured to derive the point in time and/or the frequency channel of the transfer of the respective support beacon from the information transferred with the respectively preceding support beacon so as to receive the respective support beacon.

In embodiments, points in time and/or frequency channels, or a time hopping pattern and/or a frequency hopping pattern of the transfer of the support beacons 123_1-123_5 may be determined on the basis of a calculation rule such as a polynomial of a LFSR (linear feedback shift register) or a PRBS (pseudo-random bit sequence) generator, wherein at least one of the support beacons (e.g. in the respective synchronization information) or the downlink data transfer 122 for the participant 106_1 comprises information about the current state of the calculation rule, wherein the participant 106_1 is configured to determine the points in time and/or the frequency channels, and/or the time hopping pattern and/or the frequency hopping pattern of the transfer of the support beacons on the basis of a calculation rule and the current state of the calculation rule so as to receive the support beacons. If the information (about the current state of the calculation rule) is contained in a support beacon, or is transferred with a support beacon, this information may be contained in the first support beacon that a participant to be newly synchronized receives, or, in other words, the base station 104 may be configured to provide the currently emitting support beacon with this information at least if, since the previous, or preceding, emission of a support beacon, a new participant has been synchronized, e.g. by means of a downlink data transfer. For example, this makes sense if many participants to be newly synchronized are added per support beacon so as to transmit this additional information only once for all participants, for example.

In embodiments, signaling information transmitted with a downlink data transfer 122 from the base station 104 to the participant 106_1 may be used for the participant 106_1 to be able to receive the support beacon 123_1 or the plurality of support beacons 123_1-123_m.

In detail, the participant 106_1 may be configured to receive, temporally synchronized to a transmitted uplink data transfer 120, a downlink data transfer 122 from the base station 104, wherein the downlink data transfer 122 comprises signaling information, wherein the signaling information signals the transfer of the one support beacon 123_1 or of at least one of the several support beacons 123_1-123_m.

In this case, the participant 106_1 may be configured to receive the one support beacon 123_1 or at least one of the several support beacons 123_1-123_m on the basis of the signaling information.

For example, the signaling information may correspond to the signaling information of section 1, wherein the signaling information signals, instead of the point-to-multipoint transfer 124, the one support beacon 123_1 or at least one of the several support beacons 123_1-123_m. Thus, the signaling information may comprise information about:
a point in time of the transfer of the one support beacon 123_1 or of at least one of the several support beacons 123_1-123_m, and/or
a frequency channel of the transfer of the one support beacon 123_1 or of at least one of the several support beacons 123_1-123_m, and/or
a time and/or frequency hopping pattern on the basis of which the one support beacon 123_1 or at least one of the several support beacons 123_1-123_m is transferred.

For example, the information about the point in time may be an absolute point in time, a relative point in time (e.g. a defined time span between the downlink data transfer 122 and the support beacon), or information from which the absolute or relative point in time may be derived, such as a number of clock cycles of an oscillator of the participant 106_1.

For example, the information about the frequency channel may be an absolute frequency channel or a relative frequency channel (e.g. an interval between a frequency channel of the downlink data transfer 122 and a frequency channel of the support beacon).

For example, the support beacons may be transferred on the basis of the telegram splitting transfer method. In the transfer of the support beacons on the basis of the telegram splitting transfer method, data, e.g. a (encoded) support beacon data packet of the physical layer, to be transferred with the respective support beacon may be divided onto a plurality of sub-data packets so that the plurality of sub-data packets each comprise only a part of the data to be transferred, wherein the plurality of sub-data packets is not transferred continuously, but distributed in time and/or frequency according to a time and/or frequency hopping pattern.

Detailed embodiments of the participant 106_1 and the base station 104 are described in more detail in the following.

### 2.1 Support Beacons for Maintaining the Synchronization

As illustrated in section 1, for a multicast transfer (point-to-multipoint data transfer) 124, the participants 106_1-106_n (cf. FIG. 3) have to synchronize to the point in time of the transfer. However, due to tolerances in the clock generators (of the participants), the synchronization is temporally limited, or the timing error increases with an increasing interval to the point in time of synchronization. If the timing error becomes too large, it is no longer feasible for a participant to receive the transfer, since the search window would have to be selected to be very large. Particularly in the case of participants 106_1-106_n with receivers that do not allow real-time processing of the reception signals, the available buffer memory represents a limitation of the search window size. Thus, a post-synchronization is required in regular intervals so as to maintain the timing error within a tolerable range. Particularly in case of a high number of participants 106_1-106_n, it is advantageous to implement the post-synchronization not by means of individual transfers to the individual participants, but by means of a mutual beacon for all or at least for a part of the participants 106_1-106_n of the communication system 100.

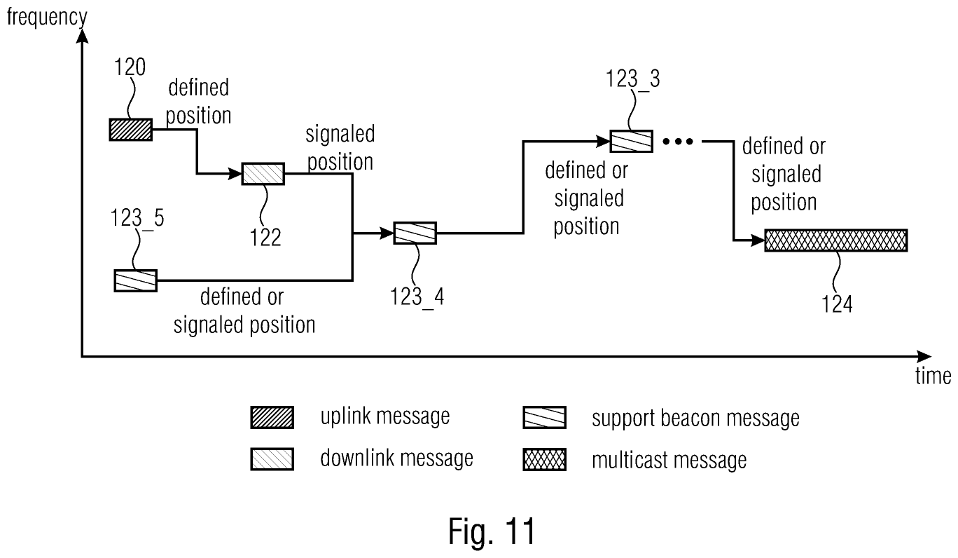

In embodiments, to this end, the base station 104 may emit with sufficient frequency a support beacon 123_1-123_5 that may be received by the synchronized participants 106_1-106-n. In this way, the participant 106-1-106-n obtain a new point in time of synchronization, and the accumulated timing error is limited. FIG. 11 shows a schematic illustration of the support beacon concept.

In detail, FIG. 11 shows, in a diagram, an occupancy of the frequency band of the communication system 100 in a point-to-multipoint data transfer 124 and a transfer of several support beacons 123_1-123_m prior to the point-to-multipoint data transfer 124, according to an embodiment of the present invention. In FIG. 11, the ordinate describes the frequency, and the abscissa describes the time.

FIG. 11 further shows an uplink data transfer 120 and a downlink data transfer 122 temporally synchronized to the uplink data transfer 120. The participant 106_1 may be synchronized on the basis of the downlink data transfer 122, e.g., which may comprise signaling information such as information about a point in time and/or a frequency channel of the transfer of the support beacon 123_4, and the synchronization of the participant 106_1 may be maintained on the basis of the support beacons.

In other words, FIG. 11 shows several support beacon transfers 123_1-123_m and a synchronization of a participant 106_1.

In embodiments, a point in time and/or a frequency and/or a hopping pattern of the respectively next support beacon (e.g. the support beacon 123_3) may result from specified values or calculation rules for the communication system 100 or the specific multicast transfer (point-to-multipoint data transfer) 124. In the case of multicast-specific values or rules, these may be transferred during the first synchronization (e.g. by means of a unicast downlink (downlink data transfer 122)). Alternatively, the information may also be transferred with preceding support beacons (e.g. the support beacon 123_4). In this case, some information may also be configured statically for the communication system 100 (e.g. frequency/hopping pattern) and other information may be transferred in the support beacon (e.g. time interval).

In embodiments, a regular transfer of the support beacons 123_1-123_m may be carried out to maintain the participants synchronized across a longer time span.

In embodiments, specified intervals and/or frequencies and/or hopping patterns may be used for the transfers of the support beacons 123_1-123_m for the communication system and/or for this multicast transfer (point-to-multipoint data transfer) 124.

In embodiments, a transfer of the point in time/interval and/or frequency and/or hopping pattern of subsequent support beacons may be carried out in the preceding support beacon.

In order to obtain a pseudo-random component in case of time and/or frequency and/or hopping pattern, these values may also be derived from data of the transfers of the support beacons, e.g. on the basis of a CRC or a support beacon counter.

In embodiments, a derivation of the interval and/or the frequency and/or the hopping pattern may be carried out from a preceding support beacon transfer, e.g. by CRC or a support beacon counter.

Transferring the time interval with the support beacons 123_1-123_m enables dynamic adaption of the intervals to the synchronized participants 106_1-106_n. For example, if the participants 106_1-106_n are synchronized with less precise clock generators, the intervals of the support beacons 123_1-123_m may be decreased so as to ensure a maximum timing error at the point in time of reception for these participants 106_1-106_n.

In embodiments, dynamic adaption of the intervals of the support beacons 123_1-123_m to the synchronization requirements of the currently synchronized participants 106_1-106_n may be carried out.

Participants 106_1-106_n with a smaller quartz error may also omit/skip transfers of support beacons 123_1-123_m and, e.g., may receive every second or third support beacon only. To this end, the intervals have to be known in advance at least for the number of support beacons to be omitted. In the case of variable parameters, this may be achieved by transmitting several intervals (frequencies, hopping patterns, etc.) in each support beacon 123_1-123_m, or by using a calculation rule that enables determining in advance the information for several support beacons. For example, a polynomial in the form of a LFSR (linear feedback shift register) comparable to a CRC or PRBS (pseudo-random bit sequence) generator may be used. With this polynomial and the current state, the participants may calculate the states for future support beacons and may derive therefrom the transfer parameters such as the point in time and/or the interval and/or the frequency and/or the hopping pattern.

In embodiments, participants 106_1-106_n with a less frequent need for post-synchronization may omit transfers of support beacons 123_1-123_m (they do not receive every support beacon).

In embodiments, calculation rules may be used for the intervals and/or the frequencies and/or the hopping patterns of the support beacons so as to be able to determine these for several support beacons in advance.

If the parameters for several support beacons may be determined in advance, it is also possible for participants to at first try, in the case of an unsuccessful reception of a transfer of a support beacon (e.g. due to channel interferences), to receive subsequent support beacons (possibly with an increased search effort). Only when this fails, a unicast uplink request (request by means of an uplink data transfer 120) is needed to obtain a new synchronization by means of a unicast downlink (a downlink data transfer 122) from the base station 104.

In embodiments, if the synchronization is lost (e.g. the support beacon is no longer received), a participant may request a unicast synchronization again.

In embodiments, if a support beacon is lost, a participant may try to synchronize itself to the subsequent support beacon, before placing a request to the base station 104.

### 2.2. Multicast Data Transfer in Support Beacons

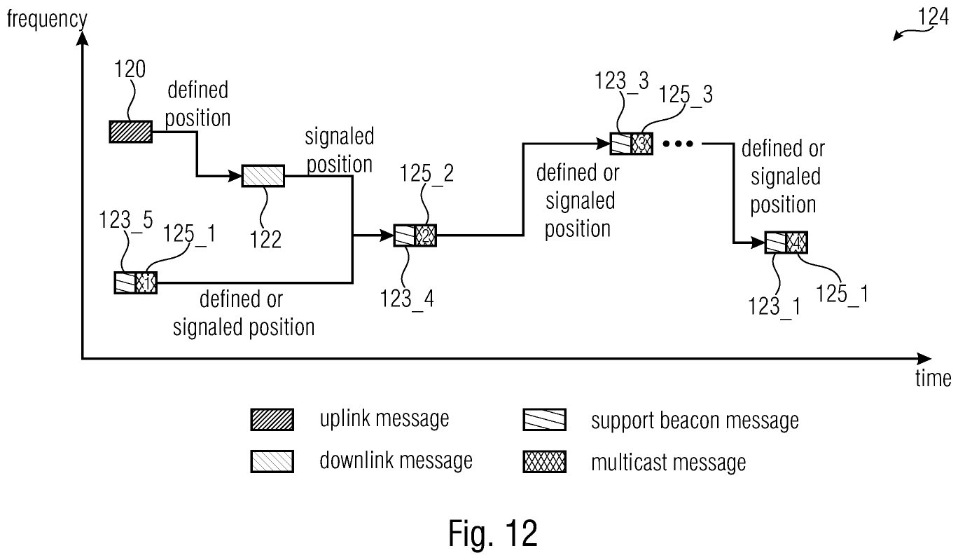

In embodiments, it is also possible to transfer the payload data of the multicast transfer (point-to-multipoint data transfer 124) distributed across the support beacons, as is shown in FIG. 12.

In detail, FIG. 12 shows an occupancy of a frequency band of the communication system 100 and the transfer of a point-to-multipoint data transfer and a transfer of several support beacons 123_1-123_m, wherein payload data of the point-to-multipoint data transfer 124 is divided onto a plurality of payload data parts 125_1-125_3 and is transferred with one of the support beacons 123_1-123_m each, according to an embodiment of the present invention. In FIG. 12, the ordinate describes the frequency, and the abscissa describes the time.

In other words, FIG. 12 shows a transfer of payload data parts 125_1-125_3 of the multicast transfer (point-to-multipoint data transfer) 124 with the support beacons 123_1-123_m. As is illustrated in FIG. 12, each support beacon carries a part of the payload data of the multicast transfer (point-to-multipoint data transfer) 124. By receiving several support beacons (e.g. the support beacons 123_1-123_4 and 123_3) the participants 106_1-106_n may obtain the entire payload data. In particular in the case of extensive multicast payload data (payload data of the point-to-multipoint data transfer), this has the advantage that the base station 104 may distribute the required duty cycle across a longer time span. Thus, for example, regulations may not allow emitting the entire payload data of the multicast transfer (point-to-multipoint data transfer) 124 in one transfer, this problem may be avoided by distribution across one day, e.g., in several support beacons (e.g. ten support beacons). In addition, a certain transfer format (e.g. a minimum length, full hopping pattern, etc.) is a common requirement, this may create unused capacities in the support beacons, which may therefore be used for payload data.

In embodiments, the multicast payload data (payload data of the point-to-multipoint data transfer) may be divided into several parts and these parts may be transferred in the context of the support beacons.

The individual parts (of the payload data of the point-to-multipoint data transfer) 124 may be repeated cyclically so as to give participants 106_1-106_n that are synchronized at a later point in time the possibility to receive missed parts in the next cycle. Participants 106_1-106_n having received all parts may stop the reception of further support beacons.

In embodiments, a cyclic repetition of the payload data parts 125_1-125_3 (e.g. of the point-to-multipoint data transfer 124) is carried out to enable a reception of all payload data parts 125_1-125_3 in the case of different start times.

In this case, the support beacons may be regarded as a kind of virtual multicast channel to which the participants are synchronized and which they leave again after all data (e.g. all payload data parts 125_1-125_3 of the point-to-multipoint data transfer 124) have been received. The base station 124 has the information about which participant has been synchronized at which point in time so as to be able to determine when all participants 106_1-106_n have obtained all data (e.g. all payload data parts 125_1-125_3 of the point-to-multipoint data transfer 124). Here, it is also conceivable to finish the transfer with a multicast containing all parts that at least one participant still could not receive.

The portion of payload data in the support beacons may also be increased or decreased dynamically, depending on the available duty cycle of the base station 104. For example, it is conceivable to transmit several payload data parts in a support beacon transfer in times of low network utilization, while transmitting in times of high network utilization only the minimum required support beacon without payload data so as to maintain the synchronization. It is also conceivable to scale the portion of payload data with the number of participants 106_1-106_n that are synchronized already. If a greater number of participants 106_1-106_n is synchronized, it makes sense to introduce a greater amount of data since these participant 106_1-106_n have to receive fewer support beacons 123_1-123_m and therefore need the synchronization less often (due to the time offsets). This reduces the current consumption for these participants 106_1-106_n. For the overall system, the current consumption is reduced on average.

In embodiments, dynamic adaption of the payload data portions in the transfers of the support beacons to the utilization of the base station 104 and/or the radio channel and/or the number of synchronized participants 106_1-106_n is carried out.

The payload data of the multicast transfer (point-to-multipoint data transfer) 124 may also be provided with an additional error protection that allows reconstructing the overall data if one or several parts (e.g. payload data parts of the point-multipoint data transfer 124) have not been received. In the extreme case, this may be done to such an extent that only a small portion of the payload data parts is required (e.g. 1/10). Thus, the error protection covers a lot more than transfer errors to be expected, e.g., and makes it possible that a participant that is only synchronized when a majority of the payload data has already been transferred still obtains the entire payload data from the remaining transfers.

Vice versa, the base station 104 may selectively cancel the multicast transfer (point-to-multipoint data transfer) 124 long before the transfer of all parts, if all participants 106_1-106_n have already obtained a sufficient number of parts (e.g. payload data parts of the point-to-multipoint data transfer) to enable a reconstruction of the payload data. Individual participants may stop the reception of further support beacons if the payload data was reconstructed from the received parts. Thus, the payload data is extended by such an amount of error protection that it is no longer the goal to provide to each participant all parts of the error protected payload data.

Instead, an error protection buffer is used to enable dynamic joining/leaving during the transfers, wherein only an arbitrary small portion of all payload data parts is really transferred. Accordingly, a significant portion of the error protected payload data parts is usually never emitted since these payload data parts are only available as a reserve, e.g., if a participant may only be synchronized very late.

In embodiments, it may be planned to transfer only a small portion of payload data parts to the participants. The payload data, or payload data parts, of the multicast transfer (point-to-multipoint data transfer) 124 have a very high error protection for reconstruction.

In embodiments, cancellation of the transfer/the reception of the multicast transfer (point-to-multipoint data transfer) 124 may be carried out by the base station 104 and/or a participant 106_1 if a sufficient amount of information has been transferred.

The advantage over a cyclic repetition is that, in the case of loss of a payload data part (of the point-to-multipoint data transfer 124), one does not have to wait for the repetition of the specific payload data part, but any other additional payload data part may be received so as to enable the reconstruction (e.g. of the point-to-multipoint data transfer 124). Thus, e.g., it is conceivable that the base station 104 at first emits a sufficient number of payload data parts to enable reconstruction of the payload data (of the point-to-multipoint data transfer 124) even in the participant synchronized last (which was able to receive the fewest parts). Subsequently, the base station 104 may emit a certain number of further payload data parts, in the event that previous payload data parts could not be received successfully.

### 2.3. Multicast Scheduling in Support Beacons

When using support beacons 123_1-123_m, the point in time of the multicast transfer (point-to-multipoint data transfer) 124 does not have to be set at the start of the synchronization. Instead, participant 106_1-106_n synchronized already may be maintained synchronous by means of the support beacons until it appears useful to perform the multicast transfer (point-to-multipoint data transfer) 124. For example, the base station 104 can wait until a sufficiently large portion of the participants 106_1-106_n was able to be synchronized via a unicast (e.g. a downlink data transfer 122 with signaling information temporally synchronized to an uplink data transfer 120), or until there are free network or duty cycle capacities. It is sufficient for the participants 106_1-106_n to know only the information for the support beacon to be received next, this may then be signaled in a support beacon before the start of the actual multicast transfer (point-to-multipoint data transfer) 124. If participants are able to skip support beacons, the signaling may be done sufficiently in advance so as to reach all participants 106_1-106_n.

In embodiments, a point in time of the start of the multicast transfer (point-to-multipoint data transfer) 124 after the start of the synchronization may be selected dynamically on the basis of participants reached already and/or a network utilization and/or a duty cycle.

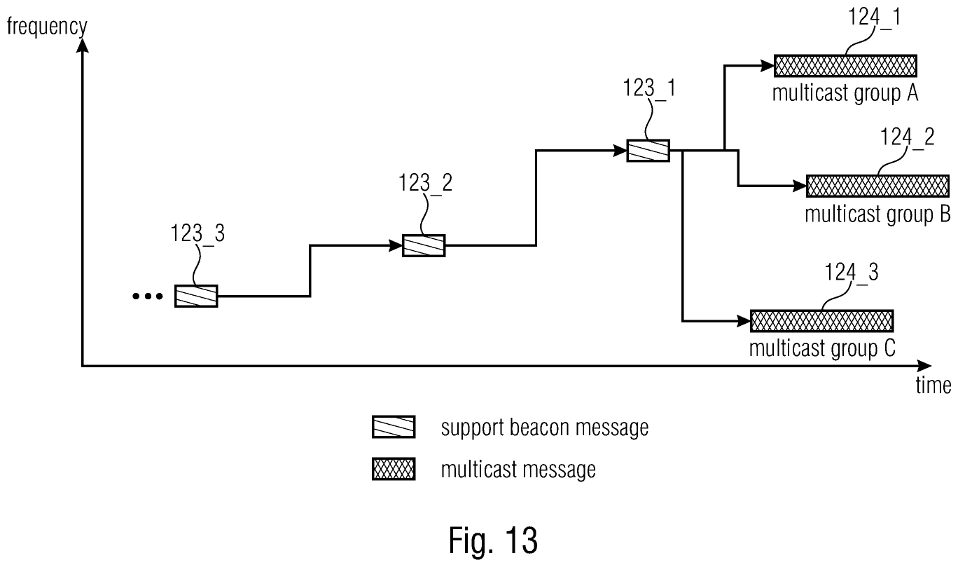

The support beacons 123_1-123_m may also be used to enable finely-granulated scheduling of the participants 106_1-106_n. Thus, for example, all participants 106_1-106_n may at first be synchronized to the virtual multicast channel (=support beacons) so as to, with addressing information in the support beacons, divide them into different multicast groups (c.f. FIG. 13) or to pick out individual participants if it turns out in the meantime that a multicast transfer (point-to-multipoint data transfer) 124 to these participants is not required.

In detail, FIG. 13 shows, in a diagram, an occupancy of the frequency band of the communication system in the transfer of three point-to-multipoint data transfers 124_1-124_3 for three different groups of participants of the communication system 100 as well as a mutual transfer of support beacons 123_1-123_m for the three different groups of participants of the communication system 100, according to an embodiment of the present invention. In FIG. 13, the ordinate describes the frequency, and the abscissa describes the time.

In other words, FIG. 13 shows a distribution of the synchronized participants onto different multicast transfers (point-to-multipoint data transfer) 124_1-124_3.

Thus, for example, several multicast transfers (point-to-multipoint data transfer) 124_1-124_3 may use one (or several) mutual support beacons. The participants are maintained mutually synchronous until the payload data transfer (e.g. the transfer of the respective point-to-multipoint data transfer 124_1-124_3) and are then divided into groups. Prior to the payload data transfer (e.g. the transfer of the respective point-to-multipoint data transfer 124_1-124_3), a dedicated interval and/or frequency and/or hopping pattern is allocated to each group for the payload data transfer. Methods of section 1 may be used to this end, for example.

In embodiments, the support beacons 123_1-123_m are used for (e.g. the transfer of) addressing information so as to divide synchronized participants onto individual multicast transfers (point-to-multipoint data transfer) 124_1-124_3 and/or to sort them out.

In this case, it is also possible to transmit in advance the multicast transfer (point-to-multipoint data transfer) to a group of participants and to keep the remaining participants synchronous with support beacons. Thus, for example, the multicast transfer (point-to-multipoint data transfer) may be completed for one group as soon as all participants of this group are synchronized, while another group still waits for participants. This may also be of advantage if, it is not possible to perform all multicast transfers (point-to-multipoint data transfer) 124_1-124_3 promptly (e.g. within a support beacon interval) with respect to each other due to the network utilization or the duty cycle.

In embodiments, early decoupling and completion of the multicast transfer (point-to-multipoint data transfer) are carried out for a group of participants, while the remaining participants are still kept synchronous through support beacons.

### 3. Further Embodiments

The embodiments described in the following may be implemented, or applied, for themselves or in combination with the above-described embodiments.

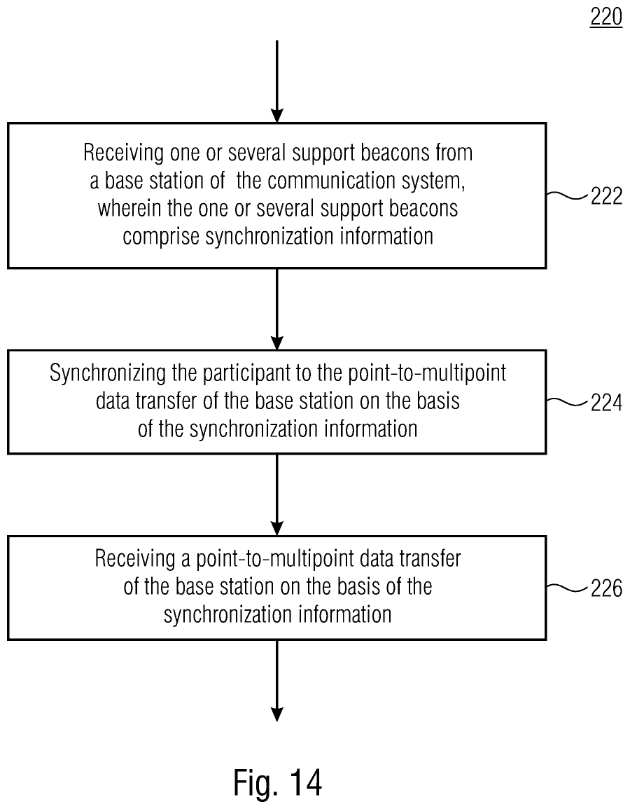

FIG. 14 shows a flow diagram of a method 220 for operating an uncoordinatedly-transmitting participant of a communication system, according to an embodiment of the present invention. The method 220 includes a step 22 of receiving one or several support beacons from a base station of the communication system, wherein the one or several support beacons comprise synchronization information. Furthermore, the method 220 includes a step 224 of synchronizing the participant to the point-to-multipoint data transfer of the base station on the basis of the synchronization information. In addition, the method 220 includes a step 226 of receiving a point-to-multipoint data transfer of the base station on the basis of the synchronization information.

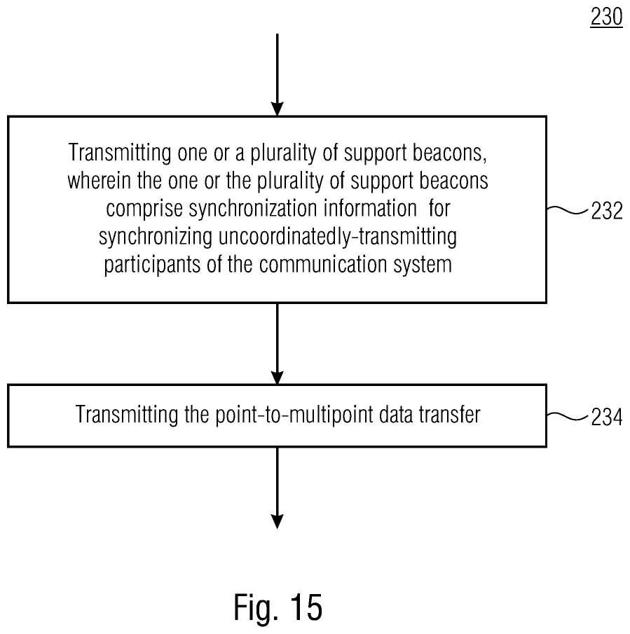

FIG. 15 shows a flow diagram of a method 230 for operating a base station of a communication system, according to an embodiment of the present invention. The method 230 includes a step 232 of transmitting one or a plurality of support beacons, wherein the one or the plurality of support beacons comprise synchronization information for synchronizing uncoordinatedly-transmitting participants of the communication system. In addition, the method 230 includes a step 234 of transmitting the point-to-multipoint data transfer.

Embodiments of the present invention make it possible to maintain participants (e.g. terminal points) synchronized over long periods of time so as to perform a flexible multicast/broadcast transfer to a large number of participants.

In embodiments, intermittently-emitted support beacons are used to refresh the synchronization on a regular basis.

In embodiments, intermittently-emitted support beacons are used as a multicast channel (point-to-multipoint channel) on demand.

In embodiments, intermittently-emitted support beacons are used for multicast scheduling.

Embodiments of the present invention concern a system (communication system) for the digital transfer of data via a radio transfer system. The data transmitted is typically transferred in several partial frequency channels of the overall available bandwidth.

Embodiments of the present invention may be used in so-called non-coordinated networks in which the radio participants transfer the data in an uncoordinated manner (without a previous allocation of a radio resource).

For example, embodiments of the present invention may be used in a communication system as defined in the ETSI TS 103 357 standard [4].

Embodiments provide a participant [e.g. a terminal point] of a communication system, [wherein the communication system communicates wirelessly in a frequency band [e.g. the ISM band] used by a plurality of [e.g. mutually uncoordinated] communication systems], wherein the participant is configured to transmit data uncoordinatedly with respect to other participants and/or a base station of the communication system, wherein the participant is configured to receive, temporally synchronized to a transmitted uplink data transfer to the base station of the communication system, a downlink data transfer from the base station, wherein the downlink data transfer comprises signaling information, wherein the participant is configured to receive a point-to-multipoint data transfer [e.g. a multicast data transfer] from the base station on the basis of the signaling information.

In embodiments, the signaling information may comprise information about a point in time of the point-to-multipoint data transfer.

For example, the information about the point in time may be an absolute point in time, a relative point in time [e.g. a defined time span between the downlink data transfer and the point-to-multipoint data transfer], or information from which the absolute or relative points in time may be derived, such as a number of clock cycles of an oscillator of the participant.

In embodiments, the signaling information may further comprise information about a frequency channel [e.g. of the frequency band used by the communication system] of the point-to-multipoint data transfer.

For example, the information about the frequency channel may be an absolute frequency channel or a relative frequency channel [e.g. a distance between a frequency channel of the downlink data transfer and a frequency channel of the point-to-multipoint data transfer].

In embodiments, the point-to-multipoint data transfer may comprise a plurality of sub-data packets transferred distributed in time and/or frequency according to a time and/or frequency hopping pattern, wherein the signaling information further comprises information about the time and/or frequency hopping pattern.

For example, the point-to-multipoint data transfer may be a telegram splitting-based data transfer. In a telegram splitting-based data transfer, the data to be transferred [e.g. [encoded] payload data of the physical layer] is divided onto a plurality of sub-data packets so that the plurality of sub-data packets each comprises only a part of the data to be transferred, wherein the plurality of sub-data packets is transferred not continuously, but distributed in time and/or frequency according to a time and/or frequency hopping pattern.

In embodiments, the information about the point in time of the point-to-multipoint data transfer may comprise a defined [e.g. desired or intentional] inaccuracy that is at least large enough so that a receiver-side synchronization to the point-to-multipoint data transfer is required for receiving the point-to-multipoint data transfer, wherein the participant is configured to perform a synchronization to the point-to-multipoint data transfer so as to receive the point-to-multipoint data transfer.

In embodiments, the defined inaccuracy may be in the range of 1 to 10,000 symbol durations.

In embodiments, the defined inaccuracy may be subject to non-linear scaling [e.g. a logarithmic scaling] as a function of a temporal interval to the point-to-multipoint data transfer so that the inaccuracy is larger as the interval to the point-to-multipoint data transfer increases.

In embodiments, the downlink data transfer may further comprise clock generator correction information [e.g. a quartz offset in ppm is used for a timer and a frequency generator] for correcting a clock deviation of a clock generator of the participant, wherein the participant is configured to correct a clock deviation of the clock generator on the basis of the clock generator correction information.

In embodiments, the uplink data transfer may be a first uplink data transfer, wherein the downlink data transfer may be a first downlink data transfer, wherein the signaling information is first signaling information, wherein the first signaling information signals a period of time or point in time [e.g. a rough point in time] for a second uplink data transfer [e.g. following the first uplink data transfer], wherein the participant is configured to transmit the second uplink data transfer to the base station in the signaled period of time and to receive, temporally synchronized to the second uplink data transfer, a second downlink data transfer from the base station, wherein the second downlink data transfer comprises second signaling information, wherein the participant is configured to receive the point-to-multipoint data transfer [e.g. the multicast data transfer] on the basis of the second signaling information.

In embodiments, the second signaling information may comprise information about a point in time of the point-to-multipoint data transfer.

In embodiments, the second signaling information may further comprise information about a frequency channel [e.g. of the frequency band used by the communication system] of the point-to-multipoint data transfer.

In embodiments, the point-to-multipoint data transfer may comprise a plurality of sub-data packets transferred distributed in time and/or frequency according to a time and/or frequency hopping pattern, wherein the second signaling information further comprises information about the time and/or frequency hopping pattern.

In embodiments, the participant may be configured, if the second downlink data transfer could not be received successfully [e.g. if the second downlink data transfer did not occur or was interrupted], to transmit a third uplink data transfer to the base station and to receive, temporally synchronized to the third uplink data transfer, a third downlink data transfer from the base station, wherein the third downlink data transfer comprises third signaling information, wherein the participant is configured to receive the point-to-multipoint data transfer [e.g. the multicast data transfer] on the basis of third signaling information.

In embodiments, the first downlink data transfer or the second downlink data transfer may further comprise clock generator correction information describing a clock deviation of a clock generator of the participant with respect to a reference clock, wherein the participant is configured to receive the point-to-multipoint data transfer by using the clock generator correction information [e.g. to correct a clock deviation of the clock generator on the basis of the clock generator correction information for receiving the point-to-multipoint data transfer].

In embodiments, the uplink data transfer may be a first uplink data transfer, wherein the downlink data transfer is a first downlink data transfer, wherein the signaling information is first signaling information, wherein the first signaling information comprises information about a rough point in time of the point-to-multipoint data transfer, [e.g. wherein the information about the rough point in time of the point-to-multipoint data transfer is too inaccurate for a reception of the point-to-multipoint data transfer], wherein the participant is configured to transmit a fourth uplink data transfer to the base station before the rough point in time of the point-to-multipoint data transfer and to receive, temporally synchronized to the fourth uplink data transfer, a fourth downlink data transfer from the base station, wherein the fourth downlink data transfer comprises fourth signaling information, wherein the participant is configured to receive the point-to-multipoint data transfer [e.g. the multicast data transfer] on the basis of the fourth signaling information.

In embodiments, the fourth signaling information may comprise information about a point in time of the point-to-multipoint data transfer.

In embodiments, the fourth signaling information may further comprise information about a frequency channel [e.g. of the frequency band used by the communication system] of the point-to-multipoint data transfer.

In embodiments, the point-to-multipoint data transfer may comprise a plurality of sub-data packets transferred distributed in time and/or frequency according to a time and/or frequency hopping pattern, wherein the fourth signaling information may further comprise information about the time and/or frequency hopping pattern.

In embodiments, the first downlink data transfer or the fourth downlink data transfer may further comprise clock generator correction information for correcting a clock deviation of a clock generator of the participant, wherein the participant is configured to correct a clock deviation of the clock generator on the basis of the clock generator correction information.

In embodiments, the signaling information may be first signaling information, wherein the first signaling information comprises information about a point in time of a support beacon, wherein the participant is configured to receive the support beacon on the basis of the first signaling information, wherein the support beacon comprises fifth signaling information, wherein the participant is configured to receive the point-to-multipoint data transfer [e.g. the multicast data transfer] on the basis of the fifth signaling information.

In embodiments, the first signaling information may further comprise information about a frequency channel [e.g. of the frequency band used by the communication system] or a frequency offset of the support beacon.

In embodiments, the fifth signaling information may comprise information about a point in time of the point-to-multipoint data transfer.

In embodiments, the fifth signaling information may further comprise information about a frequency channel [e.g. of the frequency band used by the communication system] of the point-to-multipoint data transfer.

In embodiments, the point-to-multipoint data transfer may comprise a plurality of sub-data packets transferred distributed in time and/or frequency according to a time and/or frequency hopping pattern, wherein the fifth signaling information further comprises information about the time and/or frequency hopping pattern.

In embodiments, the downlink data transfer or the support beacon may further comprise clock generator correction information for correcting a clock deviation of a clock generator of the participant, wherein the participant is configured to correct a clock deviation of the clock generator on the basis of the clock generator correction information.

In embodiments, the participant may be configured to transmit data asynchronously to other participants and/or the base station of the communication system.

For example, the participant may be configured to transmit the uplink data transfer asynchronously to the base station.

In embodiments, the participant may be configured to transmit the uplink data transfer to the base station at a random or pseudo-random point in time.

In embodiments, the uplink data transfer may comprise a plurality of sub-data packets transferred distributed in time and/or frequency according to a time and/or frequency hopping pattern.

For example, the uplink data transfer may be a telegram splitting-base data transfer. In a telegram splitting-base data transfer, the data to be transferred [e.g. (encoded) payload data of the physical layer] is divided onto a plurality of sub-data packets so that the plurality of sub-data packets each comprises only a part of the data to be transferred, wherein the plurality of sub-data packets is transferred not continuously, but distributed in time and/or frequency according to a time and/or frequency hopping pattern.

In embodiments, the downlink data transfer may comprise a plurality of sub-data packets transferred distributed in time and/or frequency according to a time and/or frequency hopping pattern.

For example, the downlink data transfer may be a telegram splitting-base data transfer. In a telegram splitting-base data transfer, the data to be transferred [e.g. (encoded) payload data of the physical layer] is divided onto a plurality of sub-data packets so that the plurality of sub-data packets each comprises only a part of the data to be transferred, wherein the plurality of sub-data packets is transferred not continuously, but distributed in time and/or frequency according to a time and/or frequency hopping pattern.

In embodiments, the participant may be a sensor node or actuator node.

In embodiments, the participant may be battery-operated.

In embodiments, the participant may comprise an energy harvesting element for generating electric energy.

Further embodiments provide a base station of a communication system [wherein the communication system communicates wirelessly in a frequency band [e.g. the ISM band] used by a plurality of [e.g. mutually uncoordinated] communication systems], wherein the base station is configured to receive an uplink data transfer from a participant of the communication system, wherein the uplink data transfer is uncoordinated, wherein the base station is configured to transmit, temporally synchronized to the received uplink data transfer of the participant, a downlink data transfer to the participant, wherein the downlink data transfer comprises signaling information, wherein the signaling information signals a subsequent point-to-multipoint data transfer or a further data transfer preceding the point-to-multipoint data transfer, wherein the base station is configured to transmit [e.g. to a plurality of participants of the communication system, wherein the participant is part of the plurality of participants] the point-to-multipoint data transfer according to the signaling information.

In embodiments, the signaling information may comprise information about a point in time of the point-to-multipoint data transfer.

For example, the information about the point in time may be an absolute point in time, a relative point in time [e.g. a defined time span between the downlink data transfer and the point-to-multipoint data transfer], or information from which the absolute or relative points in time may be derived, such as a number of clock cycles of an oscillator of the participant.

In embodiments, the signaling information may further comprise information about a frequency channel [e.g. of the frequency band used by the communication system] of the point-to-multipoint data transfer.

For example, the information about the frequency channel may be an absolute frequency channel or a relative frequency channel [e.g. a distance between a frequency channel of the downlink data transfer and a frequency channel of the point-to-multipoint data transfer].

In embodiments, the point-to-multipoint data transfer may comprise a plurality of sub-data packets transferred distributed in time and/or frequency according to a time and/or frequency hopping pattern, wherein the signaling information further comprises information about the time and/or frequency hopping pattern.

For example, the point-to-multipoint data transfer may be a telegram splitting-based data transfer. In a telegram splitting-based data transfer, the data to be transferred [e.g. [encoded] payload data of the physical layer] is divided onto a plurality of sub-data packets so that the plurality of sub-data packets each comprises only a part of the data to be transferred, wherein the plurality of sub-data packets is transferred not continuously, but distributed in time and/or frequency according to a time and/or frequency hopping pattern.

In embodiments, the information about the point in time of the point-to-multipoint data transfer may comprise a defined [e.g. desired or intentional] inaccuracy that is at least large enough so that a receiver-side synchronization to the point-to-multipoint data transfer is required for receiving the point-to-multipoint data transfer.

In embodiments, the defined inaccuracy may be in the range of 1 to 10,000 symbol durations.

In embodiments, the defined inaccuracy may be subject to non-linear scaling as a function of a temporal interval to the point-to-multipoint data transfer so that the inaccuracy is larger as the interval to the point-to-multipoint data transfer increases.

In embodiments, the base station may be configured to determine a clock deviation of a clock generator of the participant on the basis of the uplink data transfer of the participant, wherein the base station is configured to provide the downlink data transfer with clock generator correction information for correcting the clock deviation of the clock generator of the participant.

In embodiments, the base station may be configured to determine a clock deviation of a clock generator of the participant on the basis of the uplink data transfer to the participant, wherein the information about the point in time of the point-to-multipoint data transfer which the signaling information comprises considers the clock deviation on the clock generator of the participant [e.g. such that the clock deviation of the clock generator is compensated], and/or wherein the information about the frequency channel of the point-to-multipoint data transfer which the signaling information comprises considers the clock deviation of the clock generator of the participant [e.g. such that the clock deviation of the clock generator is compensated].

In embodiments, the uplink data transfer may be a first uplink data transfer, wherein the downlink data transfer is a first downlink data transfer, wherein the signaling information is first signaling information, wherein the first signaling information signals a period of time or point in time [e.g. a rough point in time] for a second uplink data transfer [e.g. following the first uplink data transfer], wherein the base station is configured to receive the second uplink data transfer from the participant in the signaled period of time and to transmit, temporally synchronized to the second uplink data transfer, a second downlink data transfer to the participant, wherein the second downlink data transfer comprises second signaling information, wherein the second signaling information signals the subsequent point-to-multipoint data transfer [e.g. wherein the second uplink data transfer and/or the second downlink data transfer is the further data transfer], wherein the base station is configured to transmit [e.g. to a plurality of participants of the communication system, wherein the participant is part of the plurality of participants] the point-to-multipoint data transfer according to the second signaling information.

In embodiments, the second signaling information may comprise information about a point in time of the point-to-multipoint data transfer.

In embodiments, the second signaling information may further comprise information about a frequency channel [e.g. of the frequency band used by the communication system] of the point-to-multipoint data transfer.

In embodiments, the point-to-multipoint data transfer may comprise a plurality of sub-data packets transferred distributed in time and/or frequency according to a time and/or frequency hopping pattern, wherein the second signaling information further comprises information about the time and/or frequency hopping pattern.

In embodiments, the base station may be configured to determine a clock deviation of a clock generator of the participant on the basis of the second uplink data transfer of the participant, wherein the base station is configured to provide the second downlink data transfer with clock generator correction information for correcting the clock deviation of the clock generator of the participant.

In embodiments, the base station may be configured to determine a clock deviation of clock generator of the participant on the basis of the first or second uplink data transfers of the participant, wherein the information about the point in time of the point-to-multipoint data transfer which the second signaling information comprises considers the clock deviation of the clock generator of the participant [e.g. such that the clock deviation of the clock generator is compensated].

In embodiments, the uplink data transfer may be a first uplink data transfer, wherein the downlink data transfer is a first downlink data transfer, wherein the signaling information is first signaling information, wherein the first signaling information comprises information about a rough point in time of the point-to-multipoint data transfer [e.g. wherein the information about the rough point in time of the point-to-multipoint data transfer is too inaccurate for a reception of the point-to-multipoint data transfer], wherein the base station is configured to receive a fourth uplink data transfer from the participant before the rough point in time of the point-to-multipoint data transfer and to transmit, temporally synchronized to the fourth uplink data transfer, a fourth downlink data transfer to the participant, wherein the fourth downlink data transfer comprises fourth signaling information, wherein the fourth signaling information signals the subsequent point-to-multipoint data transfer, [e.g. wherein the fourth uplink data transfer and/or the fourth downlink data transfer is the further data transfer], wherein the base station is configured to transmit [e.g. to a plurality of participants of the communication system, wherein the participant is part of the plurality of participants] the point-to-multipoint data transfer according to the fourth signaling information.

In embodiments, the fourth signaling information may comprise information about a point in time of the point-to-multipoint data transfer.

In embodiments, the fourth signaling information may further comprise information about a frequency channel [e.g. of the frequency band used by the communication system] of the point-to-multipoint data transfer.

In embodiments, the point-to-multipoint data transfer may comprise a plurality of sub-data packets transferred distributed in time and/or frequency according to a time and/or frequency hopping pattern, wherein the fourth signaling information may further comprise information about the time and/or frequency hopping pattern.

In embodiments, the base station may be configured to determine a clock deviation of a clock generator of the participant on the basis of the fourth uplink data transfer of the participant, wherein the base station is configured to provide the fourth downlink data transfer with clock generator correction information for correcting the clock deviation of the clock generator of the participant.

In embodiments, the base station may be configured to determine a clock deviation of a clock generator of the participant on the basis of the fourth uplink data transfer of the participant, wherein the information about the point in time of the point-to-multipoint data transfer which the fourth signaling information comprises considers the clock deviation on the clock generator of the participant [e.g. such that the clock deviation of the clock generator is compensated], and/or wherein the information about the frequency channel of the point-to-multipoint data transfer which the fourth signaling information comprises considers the clock deviation of the clock generator of the participant [e.g. such that the clock deviation of the clock generator is compensated].

In embodiments, the signaling information may be first signaling information, wherein the first signaling information comprises information about a point in time of a support beacon, wherein the base station is configured to transmit [e.g. to a plurality of participants of the communication system, wherein the participant is part of the plurality of participants] the support beacon according to the first signaling information, wherein the support beacon comprises fifth signaling information, wherein the fifth signaling information signals the subsequent point-to-multipoint data transfer [e.g. wherein the support beacon is the further data transfer].

In embodiments, the first signaling information may further comprise information about a frequency channel [e.g. of the frequency band used by the communication system] of the support beacon.

In embodiments, the fifth signaling information may comprise information about a point in time of the point-to-multipoint data transfer.

In embodiments, the fifth signaling information may further comprise information about a frequency channel [e.g. of the frequency band used by the communication system] of the point-to-multipoint data transfer.

In embodiments, the point-to-multipoint data transfer may comprise a plurality of sub-data packets transferred distributed in time and/or frequency according to a time and/or frequency hopping pattern, wherein the fifth signaling information further comprises information about the time and/or frequency hopping pattern.

In embodiments, the base station may be configured to determine a clock deviation of a clock generator of the participant on the basis of the uplink data transfer of the participant, wherein the base station is configured to provide the downlink data transfer or the support beacon with clock generator correction information for correcting the clock deviation of the clock generator of the participant.

In embodiments, the base station may be configured to determine a clock deviation of a clock generator of the participant on the basis of the uplink data transfer of the participant, wherein the information about the point in time of the point-to-multipoint data transfer which the fifth signaling information comprises considers the clock deviation of the clock generator of the participant [e.g. such that the clock deviation of the clock generator is compensated].

Further embodiments provide a method for operating a participant of a communication system. The method includes a step of transmitting an uplink data transfer to a base station of the communication system, wherein the uplink data transfer is uncoordinated.

Furthermore, the method includes a step of receiving, temporally synchronized to the uplink data transfer, a downlink data transfer from the base station, wherein the downlink data transfer comprises signaling information. Furthermore, the method includes a step of receiving a point-to-multipoint data transfer [e.g. a multicast data transfer] from the base station on the basis of the signaling information.

Further embodiments provide a method for operating a base station of a communication system. The method includes a step of receiving an uplink data transfer from a participant of the communication system, wherein the uplink data transfer is uncoordinated. Furthermore, the method includes a step of transmitting, temporally synchronized to the uplink data transfer, a downlink data transfer to the participant, wherein the downlink data transfer comprises signaling information, wherein the signaling information signals a subsequent point-to-multipoint data transfer or a further data transfer preceding the point-to-multipoint data transfer. Furthermore, the method includes a step of transmitting [e.g. to a plurality of participants of the communication system, wherein the participant is part of the plurality of participants] the point-to-multipoint data transfer according to the signaling information.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded. The data carrier, the digital storage medium, or the recorded medium are typically tangible, or non-volatile.

A further embodiment of the inventive method thus is a data stream or a sequence of signals representing the computer program for performing any of the methods described herein.

The data stream or the sequence of signals may be configured, for example, to be transmitted via a data communication link, for example via the internet.

A further embodiment includes a processing unit, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

For example, the apparatuses described herein may be implemented using a hardware device, or using a computer, or using a combination of a hardware device and a computer.

The apparatuses described herein, or any components of the apparatuses described herein, may at least be partially implement in hardware and/or software (computer program).

For example, the methods described herein may be implemented using a hardware device, or using a computer, or using a combination of a hardware device and a computer.

The methods described herein, or any components of the methods described herein, may at least be partially implement by performed and/or software (computer program).

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### BIBLIOGRAPHY

[1] G. Kilian, M. Breiling, H. H. Petkov, H. Lieske, F. Beer, J. Robert, and A. Neuberger, “Increasing Transmission Reliability for Telemetry Systems Using Telegram Splitting,” IEEE Transactions on Communications, vol. 63, no. 3, pp. 949-961, March 2015.
[2] DE 10 2011 082 098 B1
[3] DE 10 2017 206 236 A1
[4] ETSI TS 103 357 Standard v1.1.1
[5] DE 10 2017 204 186 A1

What is claimed is:

1. Participant of a communication system,
wherein the participant is configured to transmit data uncoordinatedly with respect to other participants and/or a base station of the communication system,
wherein the participant is configured to receive one or several support beacons from the base station of the communication system, wherein the one or several support beacons comprise synchronization information,
wherein the participant is configured to receive a point-to-multipoint data transfer of the base station on the basis of the synchronization information,
wherein the participant is configured to receive, temporally synchronized to an uplink data transfer transmitted to the base station, a downlink data transfer from the base station, wherein the downlink data transfer comprises signaling information, wherein the signaling information signals the transfer of the support beacon or of at least one of the several support beacons,
wherein the participant is configured to receive the one or at least one of the several support beacons on the basis of the signaling information.

2. Participant according claim 1,
wherein the signaling information comprises information about at least one of:
a point in time or time interval of the transfer of the one support beacon or of at least one of the several support beacons,
a frequency channel or frequency interval of the transfer of the one support beacon or of at least one of the several support beacons,
a time and/or frequency hopping pattern based on which the support beacons are transferred.

3. Participant according to claim 1,
wherein the synchronization information comprises information about at least one of:
a point in time or time interval of the transfer of a further support beacon and/or of the point-to-multipoint data transfer,
a frequency channel or frequency interval of the transfer of a further support beacon and/or of the point-to-multipoint data transfer, and
a time and/or frequency hopping pattern on the basis of which the further support beacon and/or the point-to-multipoint data transfer is transferred.

4. Participant according to claim 1,
wherein the synchronization information comprises a synchronization sequence for synchronizing the participant to the respective support beacon,
wherein the participant is configured to synchronize itself to the respective support beacon on the basis of the synchronization sequence.

5. Participant according to claim 1,
wherein the participant is configured to receive the several support beacons so as to synchronize itself and/or maintain itself synchronized to the point-to-multipoint data transfer of the base station on the basis of the synchronization information comprised by the support beacons.

6. Participant according to claim 1,
wherein the several support beacons are transferred in regular intervals or in intervals that are regular on average, wherein the participant knows the intervals between the transfers of the support beacons,
or wherein the several support beacons are transferred at specified points in time and/or with specified time intervals and/or in specified frequency channels and/or in specified frequency channel intervals and/or according to a specified time hopping pattern and/or according to a specified frequency hopping pattern;
or wherein at least one of the support beacons comprises information about a transfer of a subsequent support beacon, wherein the participant is configured to receive the subsequent support beacon on the basis of the information about the transfer of the subsequent support beacon;
or wherein a point in time and/or a frequency channel of the transfer of at least one of the support beacons is derived from information transferred with a preceding support beacon, wherein the participant is configured to derive the point in time and/or the frequency channel of the transfer of the at least one support beacon from the information transferred with the preceding support beacon so as to receive the at least one support beacon;
or wherein points in time and/or frequency channels, or a time hopping pattern and/or a frequency hopping pattern of the transfer of the several support beacons are determined on the basis of a calculation rule, wherein the signaling information and/or the synchronization information of at least one of the support beacons comprises information about a current state of the calculation rule, wherein the participant is configured to determine the points in time and/or the frequency channels, and/or the time hopping pattern and/or the frequency hopping pattern of the transfer of the several support beacons on the basis of the calculation rule and the current state of the calculation rule so as to receive the several support beacons (123_1-123_m).

7. Participant according to claim 1,
wherein payload data of the point-to-multipoint data transfer are divided into a plurality of payload data parts,
wherein at least one part of the payload data parts is respectively transferred together with a support beacon.

8. Participant according to claim 1,
wherein the support beacon or at least one of several support beacons comprises information about the point-to-multipoint data transfer,
wherein the participant is configured to receive the point-to-multipoint data transfer on the basis of the information about the point-to-multipoint data transfer.

9. Participant according to claim 1,
wherein the support beacon or at least one of the several support beacons comprises point-to-multipoint data transfer allocation information, wherein one of several point-to-multipoint data transfers of the base station is allocated for reception to the participant on the basis of the point-to-multipoint data transfer allocation information.

10. Base station of a communication system,
wherein the base station is configured to transmit one or a plurality of support beacons, wherein the one or the plurality of support beacons comprise synchronization information for synchronizing uncoordinatedly-transmitting participants of the communication system,
wherein the base station is configured to transmit the point-to-multipoint data transfer,
wherein the base station is configured to receive an uplink data transfer from one of the participants of the communication system, wherein the uplink data transfer is uncoordinated,
wherein the base station is configured to transmit, temporally synchronized to the received uplink data transfer of the participant, a downlink data transfer to the participant, wherein the downlink data transfer comprises signaling information, wherein the signaling information signals the transfer of the support beacon or of at least one of the plurality of support beacons.

11. Base station according to claim 10,
wherein the signaling information comprises information about at least one of:
a point in time or time interval of the transfer of the one support beacon or of at least one of the several support beacons,
a frequency channel or frequency interval of the transfer of the one support beacon or of at least one of the several support beacons, and
a time and/or frequency hopping pattern based on which the support beacons are transferred.

12. Base station according to claim 10,
wherein the synchronization information comprises information about at least one of:
a point in time or time interval of the transfer of a further support beacon or of the point-to-multipoint data transfer,
a frequency channel or frequency interval of the transfer of a further support beacon or of the point-to-multipoint data transfer, and
a time and/or frequency hopping pattern based on which the further support beacon or the point-to-multipoint data transfer is transferred.

13. Base station according claim 12,
wherein the synchronization information comprises a synchronization sequence for synchronizing the participant to the respective support beacon.

14. Base station according to claim 13,
wherein the support beacons each comprise synchronization information for synchronizing and/or maintaining the synchronization of participants to the point-to-multipoint data transfer.

15. Base station according to claim 10,
wherein the base station is configured to transfer the plurality of support beacons in regular intervals or in intervals that are regular on average;
or wherein the base station is configured to transfer the plurality of support beacons at specified points in time and/or with specified time intervals and/or in specified frequency channels and/or in specified frequency channel intervals and/or according to a specified time hopping pattern and/or according to a specified frequency hopping pattern;
or wherein the base station is configured to provide at least one of the support beacons with information about a transfer of a subsequent support beacon;
or wherein the base station is configured to adapt the transfer intervals of the support beacons to the temporal accuracy of the participants determined for the reception of the support beacons;
or wherein the base station is configured to derive a point in time and/or a frequency channel of the transfer of at least one of the support beacons from information transferred with a preceding support beacon;
or wherein the base station is configured to determine points in time and/or frequency channels and/or a time hopping pattern and/or a frequency hopping pattern of the transfer of the several support beacons on the basis of a calculation rule, wherein the base station is configured to provide the signaling information and/or the synchronization information of at least one of the support beacons with information about a current state of the calculation rule.

16. Base station according to claim 15,
wherein the base station is configured to divide payload data of the point-to-multipoint data transfer into a plurality of payload data parts,
wherein the base station is configured to transfer at least a part of the payload data parts each together with a support beacon.

17. Base station according to claim 10,
wherein the base station is configured to provide the support beacon or at least one of the plurality of support beacons with information about the point-to-multipoint data transfer.

18. Base station according to claim 10,
wherein the base station is configured to provide the support beacon or at least one of the several support beacons with point-to-multipoint data transfer allocation information, wherein one of several point-to-multipoint data transfers of the base station is allocated for reception to groups of participants on the basis of the point-to-multipoint data transfer allocation information.

19. Participant of a communication system,
wherein the participant is configured to transmit data uncoordinatedly with respect to other participants and/or a base station of the communication system,
wherein the participant is configured to receive one or several support beacons from the base station of the communication system, wherein the one or several support beacons comprise synchronization information,
wherein the participant is configured to receive a point-to-multipoint data transfer of the base station on the basis of the synchronization information,
wherein at least one of the support beacons comprises information about a transfer of a subsequent support beacon,
wherein the participant is configured to receive at least one of the subsequent support beacons on the basis of the information about the transfer of a subsequent support beacon.

20. Base station of a communication system,
wherein the base station is configured to transmit one or a plurality of support beacons, wherein the one or the plurality of support beacons comprise synchronization information for synchronizing uncoordinatedly-transmitting participants of the communication system,
wherein the base station is configured to transmit the point-to-multipoint data transfer,
wherein the base station is configured to provide at least one of the support beacons with information about a transfer of a subsequent support beacon.
